(19) United States
(12) Patent Application Publication
(10) Pub. No.: US 2017/0363053 A1
(43) Pub. Date: Dec. 21, 2017

(54) COOLING DEVICE FOR INJECTOR

(71) Applicants: DENSO CORPORATION, Kariya-city (JP); SOKEN, INC., Nishio-city (JP)

(72) Inventors: Katsuhiro ICHIHASHI, Nishio-city (JP); Hiroshi OHARA, Kariya-city (JP)

(21) Appl. No.: 15/600,888

(22) Filed: May 22, 2017

(30) Foreign Application Priority Data
Jun. 15, 2016 (JP) 2016-119143
Jun. 15, 2016 (JP) 2016-119144

(51) Int. Cl. F02M 53/04; B01D 53/94; F01N 3/20; F01P 3/12

(52) U.S. Cl. CPC F02M 53/04; F01P 3/12; B01D 53/9495; F01N 3/2066; F01N 2610/02

(57) ABSTRACT

A partitioning wall is provided in a fluid space formed between a cover member and a body member, which surrounds a forward end of a fluid injection valve. The partitioning wall divides the fluid space into an inlet-side fluid space and an outlet-side fluid space in a circumferential direction of the fluid injection valve. A forward-end space, which is formed at a bottom of the fluid space, is communicated to the inlet-side and the outlet-side fluid spaces, so that cooling water flows from the inlet-side fluid space to the outlet-side fluid space through the forward-end space. The cooling water circulates in the forward-end space surrounding the forward end of the fluid injection valve to effectively cool down the fluid injection valve.

### CROSS REFERENCE TO RELATED APPLICATION

This application is based on Japanese Patent Applications No. 2016-119143 filed on Jun. 15, 2016 and No. 2016-119144 filed on Jun. 15, 2016, the disclosures of which are incorporated herein by reference.

### FIELD OF TECHNOLOGY

The present disclosure relates to a cooling device for a fluid injection valve, which injects fluid into an exhaust pipe of an internal combustion engine.

### BACKGROUND

A urea SCR (Selective Catalytic Reduction) system is known in the art, which purifies exhaust gas emitted from an internal combustion engine (hereinafter, the engine). According to the urea SCR system, a catalyst is provided in an exhaust pipe of the engine in order to reduce and purify nitrogen oxide (NOx) contained in the exhaust gas and a fluid injection valve is provided in the exhaust pipe at an upstream side of the catalyst in order to inject urea aqueous solution as reducing agent.

Temperature of the exhaust gas is high. A forward end of a nozzle of the fluid injection valve, at which an injection hole is formed, is exposed to the exhaust gas of high temperature. When the forward end of the nozzle becomes high temperature, temperature of the urea aqueous solution in the nozzle is correspondingly increased. When the urea aqueous solution of high temperature is in contact with a nozzle material, such as, stainless steel, the nozzle material is easily dissolved. Then, it may become difficult to exactly control an injection amount of the urea aqueous solution.

A cooling device for the fluid injection valve is known in the art, for example, as disclosed in Japanese Patent No. 5,863,981 B2 (a first prior art). In the fluid injection valve of this prior art, a cup-shaped guide member is located in an outside housing member, in which cooling fluid flows for cooling the fluid injection valve. The cooling fluid is guided by the guide member in a main cooling space formed between the outside housing member and an inside housing member, wherein the guide member is arranged between the outside housing member and the inside housing member in a radial direction. Multiple openings are formed at a lower-side end of the guide member. At first, the cooling fluid flows into an outside fluid space formed between the outside housing member and the guide member, and flows in the outside fluid space in an axial-downward direction of the fluid injection valve along an outer peripheral surface of the guide member. Then, the cooling fluid flows from the outside fluid space into an inside fluid space formed between the inside housing member and the guide member through the openings. The cooling fluid flows in the inside fluid space along an inner peripheral surface of the guide member, more exactly, in an axial-upward direction from the openings to an upper-side portion of the guide member.

Another cooling device is known in the art, for example, as disclosed in Japanese Patent Publication No. 2012-137021 (a second prior art), for cooling down a fuel injection valve. According to the second prior art, the cooling device has an accommodation portion defining an accommodation space for accommodating a fuel injector. A cooling-water passage is formed in the cooling device, wherein an inlet port and an outlet port for cooling water are formed at both radial sides of the cooling-water passage. The cooling-water passage extends along an inner peripheral surface of the accommodation portion from the inlet port to the outlet port so as to form a circulation passage, which goes around an entire circumference of the accommodation space. In addition, a cross sectional area of the circulation passage is made to be smaller than a cross sectional area of a supply passage for supplying the cooling water into the cooling-water passage, in order to increase flow speed of the cooling water flowing through the circulation passage and to thereby increase cooling performance of the fuel injection valve.

In the fluid injection valve of the above first prior art, heat exchange is done between the cooling fluid and a whole inner peripheral surface of the outside housing member when the cooling fluid flows in the outside fluid space and reaches a forward end portion of the fluid injection valve, wherein the outside housing member is arranged at an outside of the guide member and the outside fluid space is formed between the outside housing member and the guide member. Temperature of the cooling fluid is increased until it reaches the forward end portion of the fluid injection valve and thereby cooling performance for the forward end portion of the fluid injection valve is decreased.

In addition, it is necessary and preferable to provide another method and/or structure of a cooling device for a fluid injection valve, which is different from that of the above second prior art but can increase the cooling performance, in a case the method and/or structure of the above second prior art cannot be applied to the fluid injection valve due to any reasons, for example, a limited assembling or mounting space for the fluid injection valve.

### SUMMARY OF THE DISCLOSURE

The present disclosure is made in view of the above problem and/or point. It is an object of the present disclosure to provide a cooling device for a fluid injection valve, which improves a cooling performance at a forward end portion of the fluid injection valve.

According to one of features of the present disclosure, a cooling device for a fluid injection valve, which injects fluid into an exhaust pipe of an internal combustion engine comprises;

an outside housing member formed in a cylindrical shape and having a cylindrical inside space;

an inside housing member formed in a cylindrical shape and inserted into the cylindrical inside space of the outside housing member so that the outside housing member and the inside housing member are connected to each other to forma fluid space of an annular shape between the outside housing member and the inside housing member, wherein the inside housing member has a cylindrical inside space into which the fluid injection valve is inserted so that the fluid injection valve is supported by the inside housing member, wherein a forward end portion of the fluid injection valve is surrounded by the fluid space in a circumferential direction of the inside housing member, and wherein cooling water is supplied into the fluid space and flows through the fluid space in order to cool down the fluid injection valve;

an inlet port formed in the outside housing member and communicated to the fluid space so that the cooling water flows into the fluid space through the inlet port;

an outlet port formed in the outside housing member and communicated to the fluid space so that the cooling water flows out of the fluid space through the outlet port;

multiple partitioning walls provided in the fluid space at such positions which are separated from each other in the circumferential direction, each of the partitioning walls extending in an axial direction and a radial direction of the fluid space to thereby divide the fluid space into multiple fluid flow areas, wherein the fluid flow areas include a first fluid flow area and a second fluid flow area, wherein the multiple fluid flow areas are arranged in the circumferential direction of the fluid space, and wherein the inlet port is communicated to the first fluid flow area and the outlet port is communicated to the second fluid flow area; and

a fluid communication portion formed at each of the partitioning walls so as to communicate neighboring fluid flow areas to each other in the circumferential direction so that the cooling water flows from the first fluid flow area to the second fluid flow area through the fluid communication portion to thereby cool down the fuel injection valve.

According to another feature of the present disclosure, a cooling device for a fluid injection valve provided in an exhaust pipe of an internal combustion engine and injecting fluid into the exhaust pipe comprises;

a fluid-space forming unit extending in an axial direction of the fluid injection valve to a forward end of the fluid injection valve, the fluid-space forming unit having an inner wall member and an outer wall member and surrounding the forward end of the fluid injection valve, and the fluid-space forming unit forming a fluid space of an annular shape between the inner wall member and the outer wall member in order that cooling water flows through the fluid space; and

at least two partitioning walls provided in the fluid space at such positions which are separated from each other in a circumferential direction of the fluid injection valve, each of the partitioning walls extending in the axial direction of the fluid injection valve so as to divide the fluid space into multiple fluid flow areas arranged in the circumferential direction of the fluid injection valve.

In the above cooling device, each of the partitioning walls forms a fluid communication portion in a forward-end space of the fluid space, and the forward-end space surrounds the forward end of the fluid injection valve so that the forward-end space is entirely communicated through the fluid communication portions in the circumferential direction,

the multiple fluid flow areas include an inlet-side fluid space and an outlet-side fluid space, which are separated from each other in the circumferential direction by the partitioning walls,

an inlet port is provided in the fluid-space forming unit at a position, which is different from a portion of the fluid space communicated to the forward-end space, so that the inlet port is communicated to the inlet-side fluid space except for the forward-end space, and

an outlet port is provided in the fluid-space forming unit at a position, which is different from the portion of the fluid space communicated to the forward-end space, so that the outlet port is communicated to the outlet-side fluid space except for the forward-end space.

According to the above feature of the present disclosure, the fluid space to which the cooling water is supplied is divided by the partitioning walls into multiple fluid flow areas in the circumferential direction. Each of the partitioning walls forms the fluid communication portion so that the forward-end space of the fluid space is communicated entirely in the circumferential direction. As a result, the cooling water enters the inlet-side fluid space through the inlet port and flows in the axial-downward direction to the forward-end space. The cooling water flows around the forward end of the fluid injection valve in the forward-end space in the circumferential direction and flows into the outlet-side fluid space. The cooling water further flows in the outside fluid space in the axial-upward direction to the outlet port, which is opposite to the flow direction in the inlet-side fluid space. The cooling water flows out of the fluid space through the outlet port. As above, the cooling water flows only in a part (the inlet-side fluid space) of the fluid space when the cooling water flows to the forward-end space. In other words, the cooling water does not flow in the entire circumferential portion (including the inlet-side and the outlet-side fluid spaces) of the fluid space when it flows to the forward-end space. As a result, it is possible to supply the cooling water into the forward-end space without increasing temperature of the cooling water, to thereby increase cooling performance at the forward end of the fluid injection valve.

According to a further feature of the present disclosure, a cooling device for a fluid injection valve of an internal combustion engine comprises;

an outside housing member having a recessed portion;

an inside housing member formed in a cylindrical shape and inserted into the recessed portion in such a way that an outer peripheral surface of the inside housing member is opposed to an inner peripheral surface of the outside housing member in a radial direction of the outside housing member via a radial space, wherein the inside housing member accommodates therein the fluid injection valve so as to surround a circumference of a forward end portion of the fluid injection valve which injects fluid into an exhaust pipe of the internal combustion engine;

a fluid space of an annular shape formed in the recessed portion between the outside housing member and the inside housing member, wherein cooling water is supplied into the fluid space in order to cool down the forward end portion of the fluid injection valve;

an inlet port formed in the outside housing member and communicated to the fluid space;

an outlet port formed in the outside housing member and communicated to the fluid space;

multiple partitioning walls, each of which is provided in the fluid space and extends not only in a radial direction of the fluid space from its inside peripheral surface to its outside peripheral surface but also in an axial direction of the fluid space, wherein the partitioning walls are arranged in a circumferential direction of the fluid space at intervals so that the fluid space is divided into multiple fluid flow areas neighboring to each other in the circumferential direction; and

a fluid communication portion formed in at least one of the partitioning walls for communicating neighboring fluid flow areas to each other in the circumferential direction of the fluid space, so that the cooling water flows in the fluid space in the circumferential direction from one of the fluid flow areas to the neighboring fluid flow area through the fluid communication portion.

According to the above feature of the present disclosure, the inside housing member of the cylindrical shape is arranged in the outside housing member having the recessed portion, so that the fluid space is formed between the outside housing member and the inside housing member, and the cooling water is supplied into the fluid space in order to cool down the fluid injection valve via the inside housing member. The cooling device of the present disclosure further has the multiple partitioning walls provided in the fluid space, each of which extends not only in the radial direction from the inside peripheral surface to the outside peripheral surface but also in the axial direction of the recessed portion. In addition, the fluid communication portion is formed in each of the partitioning walls in order to communicate the neighboring fluid flow areas to each other in the circumferential direction. It is possible by the partitioning walls to make the cooling water to flow in the fluid space not only in the axial direction but also in the circumferential direction, to thereby elongate a length of the fluid passage for the cooling water. As a result, it is possible to increase cooling performance of the fluid injection valve, which is cooled down by the cooling water via the inside housing member.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross sectional view showing a fluid injection valve and an injector supporting unit according to a first embodiment of the present disclosure in a position at which partitioning walls are not located, wherein the cross sectional view corresponds to a view on a plane in parallel to a center axis line of the fluid injection valve;

FIG. 2 is a schematic cross sectional view, which is taken along a line II-II in FIG. 1 and shows the fluid injection valve and the injector supporting unit in another position at which the partitioning walls are located;

FIG. 3 is a schematic cross sectional view, which is taken along a line III-III in FIG. 2 and shows the fluid injection valve and the injector supporting unit, wherein the cross sectional view corresponds to a view on a plane perpendicular to the center axis line of the fluid injection valve at a position of an upstream side of a forward end portion of the fluid injection valve;

FIG. 4 is a schematic cross sectional view, which is taken along a line IV-IV in FIG. 2 and shows the fluid injection valve and the injector supporting unit, wherein the cross sectional view corresponds to a view on a plane perpendicular to the center axis line of the fluid injection valve at a position of the forward end portion of the fluid injection valve;

FIG. 5 is a schematic perspective view showing an inner peripheral surface of an outside housing member, an inside housing member and the partitioning walls and further showing flow directions of cooling water;

FIG. 6 is a graph showing a temperature change at the forward end portion of the fluid injection valve as well as a change of pressure loss of the injector supporting unit with respect to an opening area of a fluid communication portion formed at the partitioning wall;

FIG. 7 is a schematic view showing an outline of an exhaust gas purifying system for an internal combustion engine;

FIG. 8 is a schematic cross sectional view showing the fluid injection valve and the injector supporting unit according to a second embodiment of the present disclosure, wherein the cross sectional view corresponds to a view on the plane perpendicular to the center axis line of the fluid injection valve;

FIG. 9 is an enlarged cross sectional view showing a portion IX in FIG. 8;

FIG. 10 is a schematically enlarged cross sectional view showing a portion corresponding to the portion IX of FIG. 8, according to a third embodiment of the present disclosure;

FIG. 11 is a schematic cross sectional view showing the fluid injection valve and the injector supporting unit according to a fourth embodiment of the present disclosure, wherein the cross sectional view corresponds to a view on the plane perpendicular to the center axis line of the fluid injection valve;

FIG. 12 is a schematic perspective view showing the inside housing member and the partitioning walls according to a fifth embodiment of the present disclosure;

FIG. 13 is a schematic side view showing the inside housing member and the partitioning wall in order to explain the fifth embodiment;

FIG. 14 is a schematic perspective view showing the inside housing member and the partitioning wall according to a sixth embodiment of the present disclosure;

FIG. 15 is a schematic side view showing the inside housing member and the partitioning wall in order to explain the sixth embodiment;

FIG. 16 is a schematic cross sectional view showing the fluid injection valve and the injector supporting unit according to a seventh embodiment of the present disclosure in a position at which the partitioning walls are not located, wherein the cross sectional view corresponds to the view on the plane in parallel to the center axis line of the fluid injection valve;

FIG. 17 is a schematic cross sectional view, which is taken along a line XVII-XVII in FIG. 16 and shows the fluid injection valve and the injector supporting unit in another position at which the partitioning walls are located;

FIG. 18 is a schematic cross sectional view, which is taken along a line XVIII-XVIII in FIG. 17, wherein the cross sectional view corresponds to a view on the plane perpendicular to the center axis line of the fluid injection valve at a position of an upstream side of a lower end of a first partitioning wall;

FIG. 19 is a schematic cross sectional view, which is taken along a line XIX-XIX in FIG. 17, wherein the cross sectional view corresponds to a view on the plane perpendicular to the center axis line of the fluid injection valve at a position of the lower end of the first partitioning wall;

FIG. 20 is a schematic perspective view of the seventh embodiment showing the inner peripheral surface of the outside housing member, the inside housing member, the first partitioning walls and second partitioning walls and further showing flow directions of the cooling water;

FIG. 21 is a schematic cross sectional view showing another example of the seventh embodiment, wherein the cross sectional view corresponds to a view on the plane perpendicular to the center axis line of the fluid injection valve at a position of the lower end of the first partitioning walls;

FIG. 22 is a schematic cross sectional view, which is taken along a line XXII-XXII in FIG. 19, showing a first example of the second partitioning wall;

FIG. 23 is a schematic cross sectional view, which is taken along the line XXII-XXII in FIG. 19, showing a second example of the second partitioning wall;

FIG. 24 is a schematic cross sectional view, which is taken along the line XXII-XXII in FIG. 19, showing a third example of the second partitioning wall;

FIG. 25 is a schematic cross sectional view showing the fluid injection valve and the injector supporting unit according to a first modification of the present disclosure (in particular, the first embodiment), wherein a fluid communication portion is formed in the partitioning wall and wherein the cross sectional view corresponds to a view on the plane in parallel to the center axis line of the fluid injection valve;

FIG. 26 is a schematic cross sectional view showing the fluid injection valve and the injector supporting unit according to a second modification of the present disclosure (in particular, the first embodiment), wherein a fluid communication portion is formed in the partitioning wall and wherein the cross sectional view corresponds to a view on the plane in parallel to the center axis line of the fluid injection valve;

FIG. 27 is a schematic cross sectional view showing the fluid injection valve and the injector supporting unit for supporting the fluid injection valve according to an eighth embodiment of the present disclosure, in a position at which the partitioning walls are located;

FIG. 28 is a schematic perspective view showing the injector supporting unit of the fluid injection valve, wherein a part of an outside housing member is removed;

FIG. 29 is a schematic cross sectional view showing the fluid injection valve and the injector supporting unit in a position at which the partitioning walls are not located;

FIG. 30 is a schematic development view showing a fluid space formed between the outside housing member and an inside housing member, wherein the fluid space is developed in a circumferential direction of the fluid injection valve and the partitioning walls are indicated in the fluid space;

FIG. 31 is a schematic cross sectional view showing the injector supporting unit, which is taken along a line XXXI-XXXI in FIG. 29;

FIG. 32 is a schematic cross sectional view showing a modification of the injector supporting unit, which is taken along the line XXXI-XXXI in FIG. 29, wherein the partitioning walls are welded to the inside housing member;

FIG. 33 is a schematic cross sectional view showing another modification of the injector supporting unit, which is taken along the line XXXI-XXXI in FIG. 29, wherein a cross section of the partitioning wall has a triangular shape and its top point is in contact with the outside housing member;

FIG. 34 is a schematic side view showing a positional relationship between the partitioning wall and the center axis line of the fluid injection valve, when an angle between a side surface of the partitioning wall and the center axis line is 0 (zero) degree;

FIG. 35 is a schematic side view showing a positional relationship between the partitioning wall and the center axis line of the fluid injection valve, when the angle between the side surface of the partitioning wall and the center axis line is an angle of “θ6” other than 0 (zero) degree;

FIG. 36 is a schematic cross sectional view showing an outer fixing member, which is attached to an exhaust pipe in a condition that the fluid injection valve is arranged in a vertical direction;

FIG. 37 is a schematic cross sectional view also showing the outer fixing member, which is attached to the exhaust pipe in a condition that the fluid injection valve is inclined with respect to the vertical direction;

FIG. 38 is a schematic cross sectional view further showing the outer fixing member, which is attached to the exhaust pipe in a condition that the fluid injection valve is arranged in a horizontal direction;

FIG. 39 is a schematic cross sectional view taken along a line XXXIX-XXXIX in FIG. 29;

FIG. 40 is a graph showing temperature change at a forward end portion of the fluid injection valve with respect to an eccentricity ratio of the fluid injection valve relative to the inside housing member of the injector supporting unit;

FIG. 41 is a schematic perspective view showing an injector supporting unit of a fluid injection valve according to a ninth embodiment of the present disclosure, wherein a part of an outside housing member is removed;

FIG. 42 is a schematic development view showing the fluid space of the ninth embodiment formed between the outside and the inside housing members, wherein the fluid space is developed in the circumferential direction of the fluid injection valve and the partitioning walls are indicated in the fluid space;

FIG. 43 is a schematic cross sectional view showing the fluid injection valve and the injector supporting unit for supporting the fluid injection valve according to a modification of the eighth embodiment;

FIG. 44 is a schematic cross sectional view showing the fluid injection valve and the injector supporting unit for supporting the fluid injection valve according to another modification of the eighth embodiment;

FIG. 45 is a schematic cross sectional view showing the fluid injection valve and the injector supporting unit for supporting the fluid injection valve according to a further modification of the eighth embodiment; and

FIG. 46 is a schematically enlarged cross sectional view showing a portion XLVI of FIG. 31.

### DETAILED DESCRIPTION OF THE EMBODIMENTS

The present disclosure will be explained hereinafter by way of multiple embodiments and/or modifications with reference to the drawings. The same reference numerals are given to the same or similar parts or portions throughout the multiple embodiments and/or modifications in order to eliminate repeated explanation.

### First Embodiment

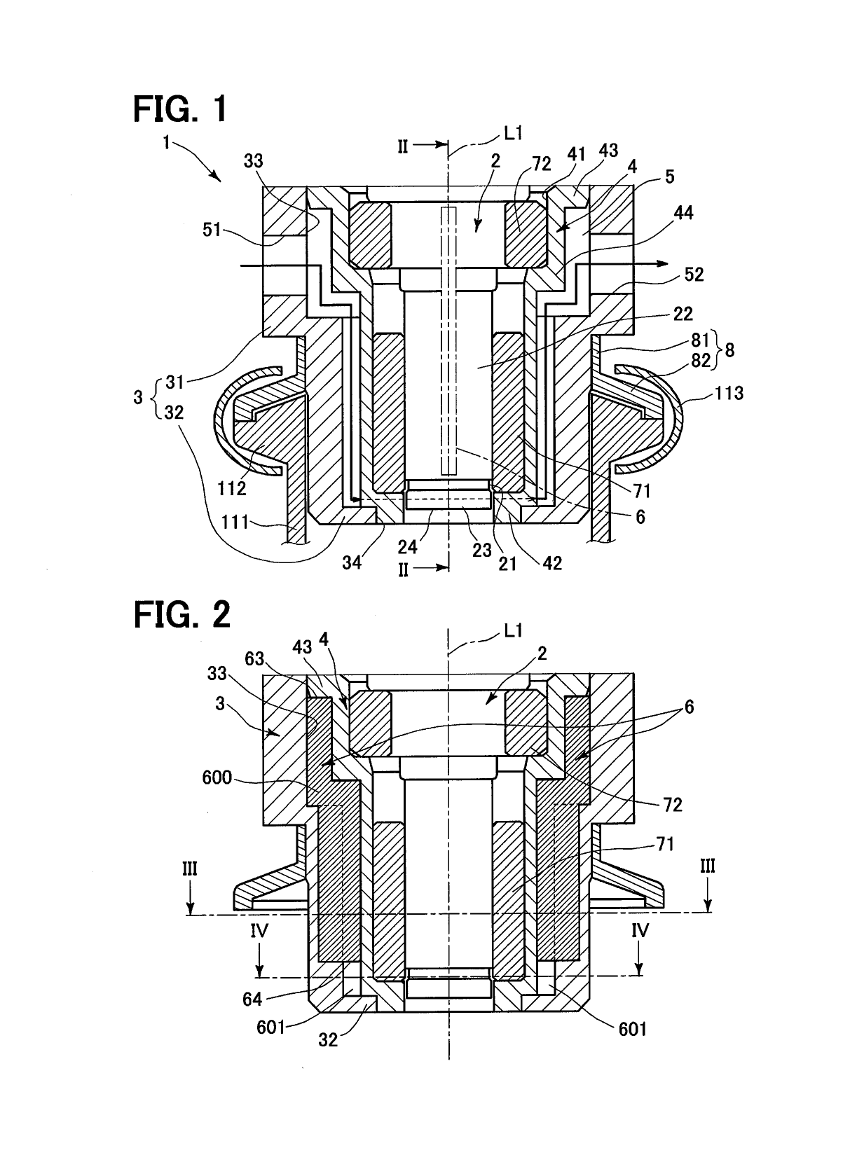

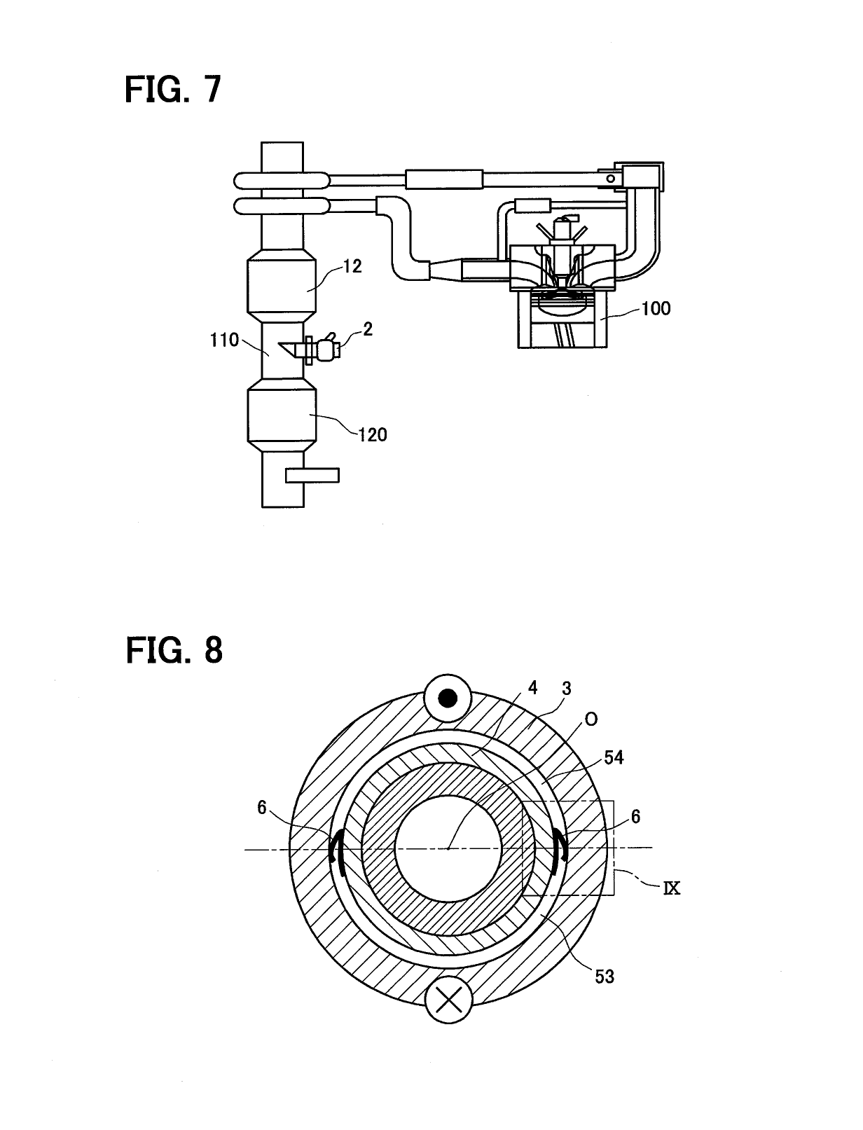

A fluid injection valve 2 (hereinafter, the injector 2) shown in FIGS. 1 and 2 is provided in an exhaust pipe 110 of an internal combustion engine 100 installed in a vehicle, for example, a diesel engine (hereinafter, the engine), as shown in FIG. 7. The injector 2 injects fluid (for example, urea aqueous solution) into the exhaust pipe 110 as reducing agent. An SCR (Selective Catalytic Reduction) catalyst 120 is provided in the exhaust pipe 110 at a downstream side of the injector 2 in order to selectively reduce nitrogen oxide (NOx) contained in exhaust gas emitted from the engine 100. In an exhaust gas purifying system shown in FIG. 7, an oxidation catalyst 12 (DOC: Diesel Oxidation Catalyst) is provided in the exhaust pipe 110 at an upstream side of the injector 2. When the urea aqueous solution is hydrolyzed by heat of the exhaust gas, ammonia (NH3) is produced. Reduction reaction is carried out by the SCR catalyst 120 between the ammonia (NH3) and the nitrogen oxide (NOx), so that the nitrogen oxide is converted into water and nitrogen. The injector 2 constitutes a part of a urea SCR system.

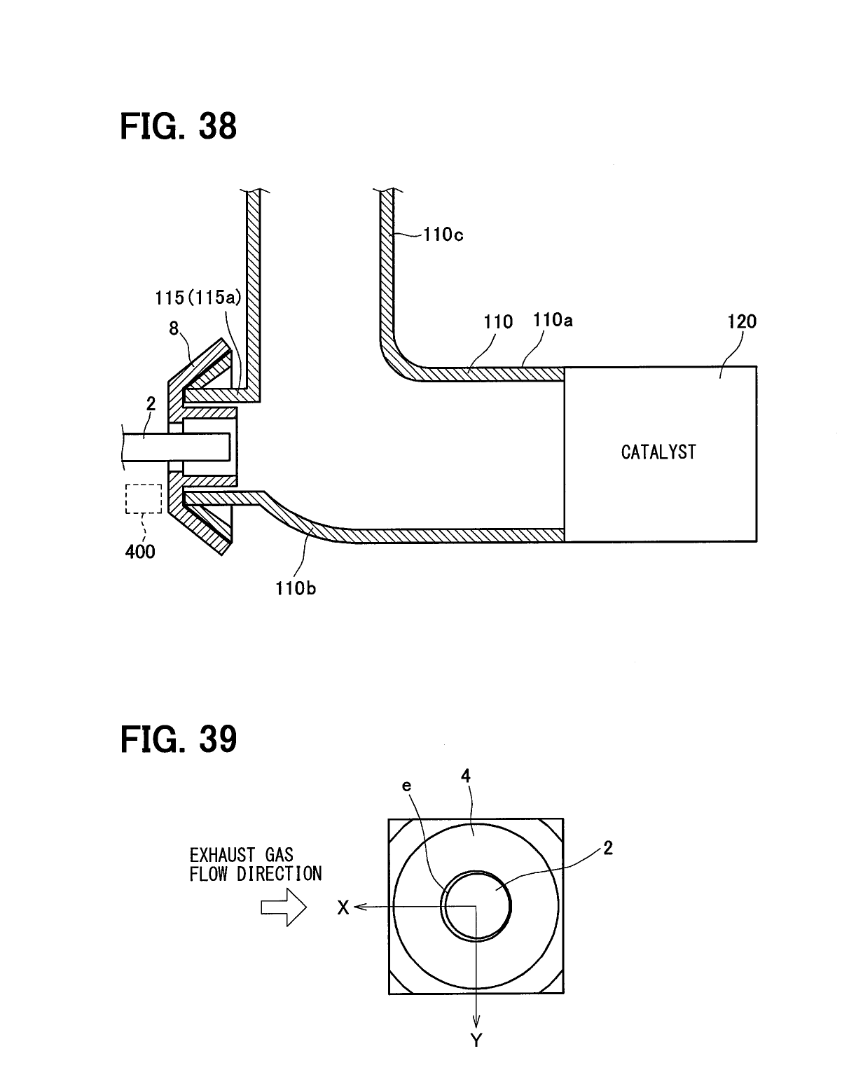

The injector 2 having an almost cylindrical shape is mounted to the exhaust pipe 110 in such a way that its center axis line L1 is generally pointed in a vertical direction. However, the injector 2 can be pointed in any direction other than the vertical direction. For example, the injector 2 may be inclined toward a downward direction with respect to the vertical direction so as to be pointed to the SCR catalyst 120 (for example, as shown in FIG. 37, which will be explained below). Alternatively, when a bent pipe portion is formed in the exhaust pipe 110 so that it has an L-letter shape and the SCR catalyst 120 is provided in a horizontal pipe portion at a downstream of the bent pipe portion of the exhaust pipe 110, the injector 2 may be mounted to the bent pipe portion of the exhaust pipe in a direction inclined by 90 degrees from the vertical direction, that is, in the horizontal direction (for example, as shown in FIG. 38, which will be also explained below).

As shown in FIG. 1, the injector 2 is composed of a nozzle body 21, a cylindrical housing 22 for supporting the nozzle body 21, an injection-hole plate 23 provided at a forward end of the nozzle body 21, a nozzle needle (not shown) movably accommodated in the nozzle body 21 and the housing 22 (hereinafter, the injector housing 22), and so on.

The injector housing 22 has an inside space of a cylindrical shape. The nozzle body 21 is provided at one axial end of the injector housing 22 (a lower side in FIG. 1). An inlet port (not shown) for the urea aqueous solution is formed at the other axial end of the injector housing 22 (an upper side in FIG. 1, opposite to the nozzle body 21), so that the urea aqueous solution stored in a tank (not shown) is supplied into the inside space of the injector housing 22 via the inlet port.

In the present disclosure, the upper side of FIG. 1 in which the inlet port is formed is referred to as an upstream side, while the lower side of FIG. 1 in which the injection-hole plate 23 is formed is referred to as a downstream side or a forward end side.

The nozzle body 21 formed in a cylindrical shape is provided at a downstream-side end of the injector housing 22 in such a manner that a part of the nozzle body 21 is inserted into the inside space of the injector housing 22. An outer peripheral surface of the nozzle body 21 and an inner peripheral surface of the injector housing 22 are in contact with each other at such an insertion portion and the nozzle body 21 is fixed to the injector housing 22 by welding at the insertion portion.

The injection-hole plate 23 is provided at an axial end of the nozzle body 21 on a side (the lower side in FIG. 1) opposite to the insertion portion of the nozzle body 21 fixed to the injector housing 22, so as to close the axial end of the nozzle body 21. An injection hole (not shown) is formed in the injection-hole plate 23 (at a forward end 24 of the injector 2) in order to inject the urea aqueous solution.

The nozzle needle (not shown) is movably accommodated in an accommodation space formed inside of the injector housing 22 and the nozzle body 21, so that the nozzle needle is capable of reciprocating in a direction of the center axis line L1 (an axial direction of the injector 2). The nozzle needle is coaxially arranged with the nozzle body 21 to form a fluid passage between the nozzle body 21 and the nozzle needle, so that the urea aqueous solution flows through the fluid passage.

The injector 2 has an actuator unit (not shown), which is composed of a solenoid and so on for driving the nozzle needle. When no electric current is supplied to the solenoid of the actuator unit, an axial end of the nozzle needle is seated on a valve seat portion (not shown) formed in the nozzle body 21, so that the fluid passage for the urea aqueous solution is closed to thereby stop injection of the urea aqueous solution via the injection hole. On the other hand, when the electric current is supplied to the solenoid, the nozzle needle is separated from the valve seat portion, so that the fluid passage for the urea aqueous solution is opened to thereby inject the urea aqueous solution into the exhaust pipe 110 via the injection hole. A connector (not shown) is provided at an upstream-side of the injector 2, so that the electric current is supplied to the solenoid of the actuator unit via the connector.

The injector 2 is fixed to the exhaust pipe 110 (FIG. 7) by an injector supporting unit 1 (hereinafter, the cooling adapter 1) shown in FIG. 1. The cooling adapter 1 has a function for fixing the injector 2 to the exhaust pipe 110 and a function for cooling the injector 2. The cooling adapter 1 is composed of an outside housing member 3 (hereinafter, a cover member 3), an inside housing member 4 (hereinafter, a body member 4), partitioning walls 6 (hereinafter, baffle plates 6), a packing 71, a seal member 72, an outer fixing member 8 and so on. The cooling adapter 1 corresponds to a cooling device for the injector 2.

The cover member 3 is formed in a cylindrical shape having a bottom end. The cover member 3 is composed of a cylindrical wall portion 31 and a bottom portion 32 formed at an axial end (a lower-side end in FIG. 1) of the cylindrical wall portion 31 for closing an inside space of the cylindrical wall portion 31. As shown in FIG. 1 or 2, the cylindrical wall portion 31 has such a shape that a diameter is stepwise changed in the axial direction (the direction of the center axis line L1). However, the shape of the cylindrical wall portion 31 is not limited to the shape shown in FIG. 1 or 2. For example, the cylindrical wall portion 31 may be formed in such a shape that the diameter thereof is constant in the axial direction along the center axis line L1. An axial end (an upper-side end in FIG. 1) of the cylindrical wall portion 31 opposite to the bottom portion 32 is formed as an open end. A side (an upper side in FIG. 1) of the open end is also referred to as an inlet side of the cover member 3. A through-hole 34 is partially formed at a center of the bottom portion 32. The through-hole 34 is formed in a circular shape having a center coinciding with a center axis line of the cylindrical wall portion 31 and having a diameter smaller than an inner diameter of the cylindrical wall portion 31. A forward end projection 42 of the body member 4 is inserted into the through-hole 34. A recessed portion 33 is formed in the cover member 3 by the cylindrical wall portion 31 and the bottom portion 32, so as to form a cylindrical inside space.

The cover member 3 surrounds the injector 2 in such a way that the body member 4 is interposed between the cover member 3 and the injector 2. The center axis line of the cover member 3 coincides with the center axis line L1 of the injector 2. The cover member 3 is made of, for example, stainless steel (SUS). The cover member 3 is also referred to as an outer wall member.

The body member 4 is formed in a cylindrical shape around the center axis line L1 of the injector 2 for accommodating the injector 2 therein. More exactly, an accommodation space 41 is formed in the body member 4 in order to accommodate the injector 2. A forward end portion of the injector 2 including the forward end 24 is accommodated in the accommodation space 41. More exactly, the injection-hole plate 23, a part of the nozzle body 21 and a part of the injector housing 22 are accommodated in the accommodation space 41. In addition, the packing 71 and the seal member 72 are accommodated in the accommodation space 41. An inner diameter of the accommodation space 41 is respectively made to be larger than an outer diameter of the injector 2 by a thickness of the packing 71 and the seal member 72. In the present embodiment, a center axis line of the accommodation space 41 coincides with the center axis line L1 of the injector 2. However, the accommodation space 41 may be formed in such a shape that the center axis line of the accommodation space 41 is eccentrically displaced from the center axis line L1 of the injector 2, as will be explained below in connection with FIG. 39.

The body member 4 is formed in such a shape that its diameter is stepwise changed in the axial direction along its center axis line. More exactly, the body member 4 is composed of the forward end projection 42 located at a downstream side of the body member 4 and having an outer diameter equal to an inner diameter of the through-hole 34 of the cover member 3, an upper-side cylindrical portion 43 located at an upstream side of the body member 4 and having an outer diameter equal to an inner diameter of an inlet-side portion of the cover member 3 (the upper-side open end of the recessed portion 33), and an intermediate cylindrical portion 44 located between the forward end projection 42 and the upper-side cylindrical portion 43 and having an outer diameter smaller than the inner diameter of the recessed portion 33 of the cover member 3.

As explained above, the forward end projection 42 is tightly inserted into the through-hole 34 of the cover member 3. The upper-side cylindrical portion 43 is located at the inlet-side portion of the recessed portion 33 so that its outer peripheral surface is tightly in contact with an inner peripheral surface of the recessed portion 33. In other words, the upper-side cylindrical portion 43 closes the inlet-side portion of the recessed portion 33. The intermediate cylindrical portion 44 forms an inside wall for a cooling-water passage. The intermediate cylindrical portion 44 is located in the recessed portion 33 at such a position opposing to the inner peripheral surface of the recessed portion 33 but being separated from the inner peripheral surface of the recessed portion 33 in a radial direction of the injector 2.

As above, the body member 4 is inserted into the recessed portion 33 of the cover member 3. The cover member 3 and the body member 4 are co-axially arranged so that the center axis line of the cover member 3 coincides with the center axis line of the body member 4.

The body member 4 is fixed to the cover member 3, for example, by welding. The welding is done at such portions, at which each of the upper-side cylindrical portion 43 and the forward end projection 42 of the body member 4 is in contact with the cover member 3. The body member 4 is made of, for example, stainless steel (SUS). The body member 4 is also referred to as an inner wall member. The cover member 3 and the body member 4 are collectively referred to as a fluid-space forming unit.

A fluid space 5 of an annular shape is formed in the recessed portion 33 between the cover member 3 and the body member 4. The fluid space 5 works as the cooling-water passage, through which cooling water flows so as to cool the injector 2. For example, engine cooling water is used as the cooling water for the injector 2. The fluid space 5 surrounds a whole circumference of the forward end portion of the injector 2 via the body member 4. More exactly, the fluid space 5 surrounds the whole circumference around the center axis line L1 of the injector 2 and axially extends along the center axis line L1 to the forward end 24 of the injector 2, that is, to the position of the injection-hole plate 23.

The axial direction of the cover member 3, that is, a direction between the inlet-side portion of the recessed portion 33 and the bottom portion 32 is also referred to as a depth direction. The fluid space 5 is closed at each axial end of the depth direction. More exactly, one axial end of the fluid space 5 in the depth direction (a lower-side end) is closed by the bottom, portion 32 of the cover member 3. The other axial end of the fluid space 5 in the depth direction (an upper-side end) is closed by the upper-side cylindrical portion 43 of the body member 4.

As shown in FIG. 1, an inlet port 51 through which the cooling water enters the fluid space 5 and an outlet port 52 through which the cooling water flows out from the fluid space 5 are respectively formed for the fluid space 5. Each of the inlet port 51 and the outlet port 52 is formed in the cover member 3 at an upstream side (an upper side) of the fluid space 5, that is, at a position of the fluid space 5 closer to not the bottom portion 32 of the cover member 3 but closer to the upper-side cylindrical portion 43 of the body member 4. Each of the inlet and the outlet ports 51 and 52 passes through a wall portion of the cover member 3 in the radial direction thereof. More exactly, each of the inlet port 51 and the outlet port 52 is formed at a position, which is located at an upstream side of a fluid communication portion 601 (FIG. 2) formed by the baffle plate 6 (explained below).

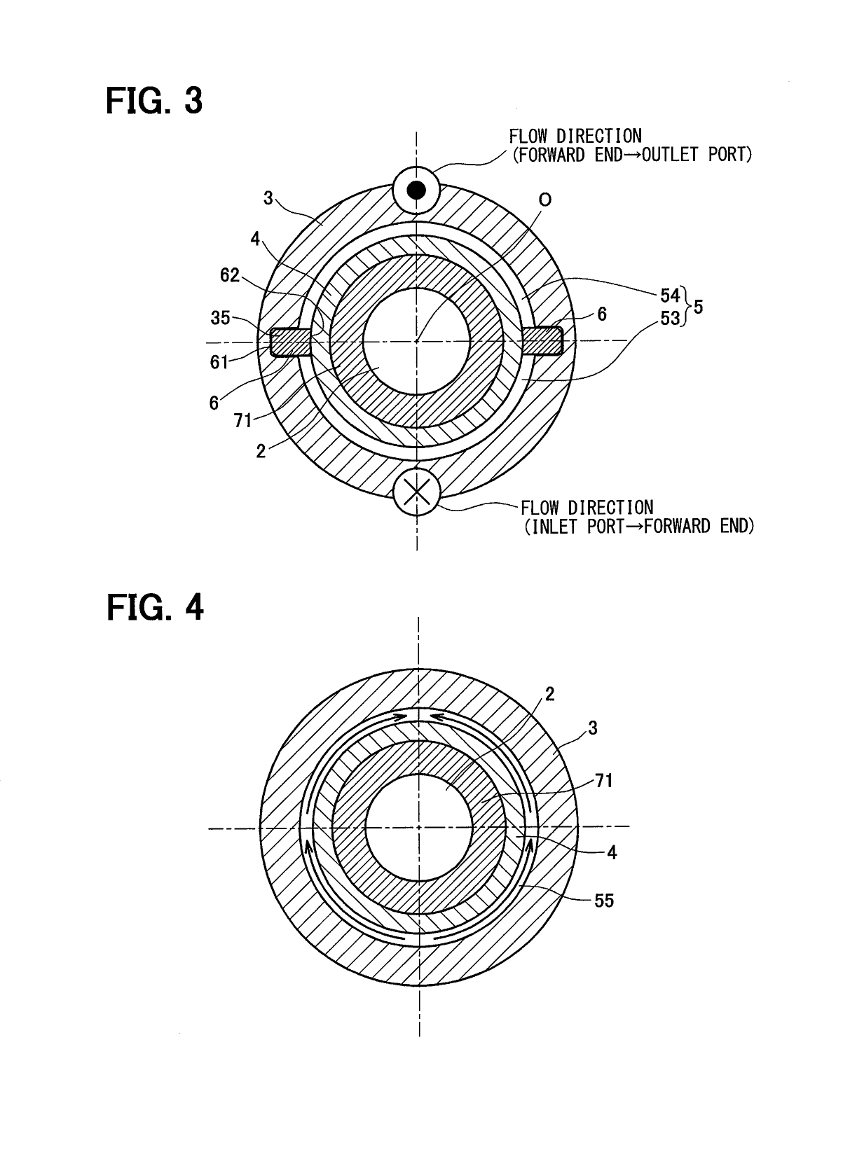

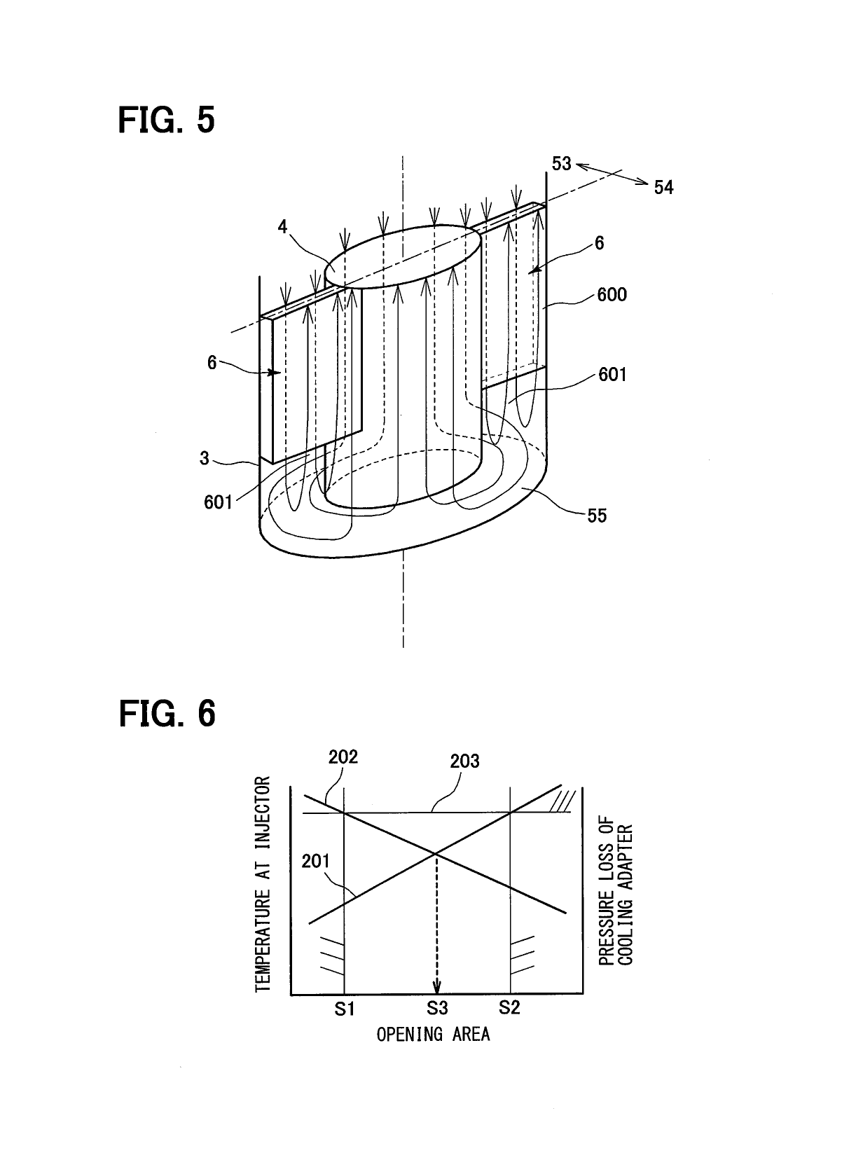

Furthermore, each of the inlet port 51 and the outlet port 52 is formed at such a circumferential position, at which the baffle plate 6 is not formed in a circumferential direction of the fluid space 5 (that is, a circumferential direction of the body member 4). More exactly, the fluid space 5 is divided by the baffle plate 6 into two fluid flow areas 53 and 54, as shown in FIG. 3 or 5. The inlet port 51 is formed in one of the fluid flow areas (a first fluid flow area 53), while the outlet port 52 is formed in the other fluid flow area (a second fluid flow area 54). In the present embodiment, the inlet port 51 and the outlet port 52 are symmetrically formed with respect to the center axis line L1 of the injector 2. In other words, the inlet port 51 and the outlet port 52 are formed at intervals of 180 degrees in the circumferential direction. Needless to say, it is not necessary to form the inlet port 51 and the outlet port 52 at such symmetric positions with respect to the center axis line L1, so long as each of the inlet port 51 and the outlet port 52 is separately formed in the fluid flow areas 53 and 54.

Each of the baffle plates 6 is provided in the fluid space 5 as the partitioning wall. As shown in FIG. 2, each of the baffle plates 6 extends between the cover member 3 and the body member 4, that is, in the radial direction of the cover member 3 and the body member 4 (that is also the radial direction of the injector 2). In addition, each of the baffle plates 6 extends in the depth direction of the fluid space 5, that is, in the axial direction of the injector 2 (the direction along the center axis line L1). In the present embodiment, a side surface 600 (FIG. 2 or 5) of the baffle plate 6 is formed by a flat surface, which faces in the circumferential direction of the fluid space 5, in such a manner that an angle in the axial direction between the side surface 600 and the center axis line L1 of the injector 2 is 0 (zero) degree. In other words, each of the baffle plates 6 is formed by a flat plate member having no inclination angle in the axial direction with respect to the center axis line L1.

As above, there are two baffle plates 6 provided in the fluid space 5 in the present embodiment. As shown in FIG. 3, each of the baffle plates 6 is provided at a symmetric position with respect to a center position “◯” of the injector 2 (equal to a position of the center axis line L1). The baffle plates 6 are arranged at equal intervals (180 degrees) in the circumferential direction of the fluid space 5 around the center position “◯”.

As explained above, the fluid space 5 is divided by the baffle plates 6 into the first and the second fluid flow areas 53 and 54 in the circumferential direction (FIG. 3). The first fluid flow area 53 for which the inlet port 51 is provided is also referred to as an inlet-side fluid space 53, while the second fluid flow area 54 for which the outlet port 52 is provided is also referred to as an outlet-side fluid space 54. Each of the inlet-side fluid space 53 and the outlet-side fluid space 54 is defined as a space equally divided in the circumferential direction. Therefore, each of a center angle formed by an arc of the inlet-side fluid space 53 and a center angle formed by an arc of the outlet-side fluid space 54 is 180 degrees.

As explained above, the baffle plate 6 is formed by the flat plate member (FIG. 5). In the present embodiment, a plate extending direction of the baffle 6 in the radial direction of the cover member 3, the body member 4 or the injector 2 is referred to as a first plate extending direction, while a plate extending direction of the baffle 6 in the axial direction of the cover member 3, the body member 4 or the injector 2 is referred to as a second plate extending direction. An outer periphery of the baffle plate 6 faces an inner wall surface of the fluid space 5. More exactly, as shown in FIG. 3, a radial-outside end 61 of the baffle plate 6 in the first plate extending direction faces the inner peripheral surface of the cover member 3. A radial-inside end 62 of the baffle plate 6 faces the outer peripheral surface of the body member 4.

As shown in FIG. 2, one axial end 63 of the baffle plate 6 in the second plate extending direction faces the upper-side cylindrical portion 43 of the body member 4, while the other axial end 64 of the baffle plate 6 in the second plate extending direction faces the bottom portion 32 of the cover member 3. In the present embodiment, the radial-outside end 61 of the baffle plate 6 facing the cover member 3 is referred to as an outer side end 61, the radial-inside end 62 of the baffle plate 6 facing the body member 4 is referred to as an inner side end 62, the axial end 63 of the baffle plate 6 facing the upper-side cylindrical portion 43 is referred to as an upper side end 63, and the axial end 64 of the baffle plate 6 facing the bottom portion 32 is referred to as a lower side end 64.

The baffle plate 6 can be fixed to any part of the fluid-space forming unit (the cover member 3 and the body member 4) by any suitable fixing method. In the present embodiment, as shown in FIG. 3, a groove 35 is formed at the inner peripheral surface of the cover member 3 in such a manner that the groove 35 extends in the axial direction of the cover member 3 (in the direction of the center axis line L1). The outer side end 61 of the baffle plate 6 is inserted into the groove 35. Since the outer side end 61 is tightly inserted into the groove 35, the baffle plate 6 is fixed to the cover member 3. The inner side end 62 is in contact with the outer peripheral surface of the body member 4. Alternatively, the baffle plate 6 can be provided in the fluid space 5 in such a manner that the inner side end 62 has a small gap with the outer peripheral surface of the body member 4.

Alternatively, the baffle plate 6 can be fixed to the body member 4 in such a way that the inner side end 62 is inserted into a groove formed at the outer peripheral surface of the body member 4 or the inner side end 62 is welded to the outer peripheral surface of the body member 4, instead of or in addition to the fitting between the groove 35 and the outer side end 61. When fixing the baffle plate 6 to the body member 4, the outer side end 61 can be in contact with the inner peripheral surface of the cover member 3 or cannot be in contact with the inner peripheral surface of the cover member 3 so that the outer side end 61 has a small gap with the inner peripheral surface of the cover member 3 in the radial direction. When the small gap is formed between the baffle plate 6 and the cover member 3, it is possible to prevent heat of the cover member 3 from being transmitted to the body member 4 or the injector 2 via the body member 4, to thereby improve cooling performance of the injector 2.

When the small gap is formed between the baffle plate 6 and the cover member 3, a dimension of the gap is set at such a small value that the cooling water does not flow through the gap. More exactly, the dimension of the small gap is made to be smaller than an opening area of the fluid communication portion 601 (explained below). According to such dimension, a pressure loss of the cooling water flowing through the small gap is larger than that of the cooling water flowing through the fluid communication portion 601. As a result, the cooling water flows not through the small gap but through the fluid communication portion 601. It is possible to suppress leakage of the cooling water through the small gap and to easily forma flow of the cooling water in the axial direction of the center axis line L1.

As shown in FIG. 2, the upper side end 63 of the baffle plate 6 is in contact with the upper-side cylindrical portion 43 of the body member 4. In other words, a fluid communication portion is not formed between the upper side end 63 and the upper-side cylindrical portion 43. However, a small gap can be formed between the upper side end 63 and the upper-side cylindrical portion 43, in such a manner that the small gap has a clearance through which the cooling water can hardly flow. In addition, the baffle plate 6 is located at such a position that a small gap is formed between the lower side end 64 of the baffle plate 6 and the bottom portion 32 of the cover member 3. In other words, the fluid communication portion 601 is formed between the lower side end 64 and the bottom portion 32.

In the present embodiment, since a whole portion of the lower side end 64 is separated from the bottom portion 32, a width of the fluid communication portion 601 in the radial direction coincides with a width of the fluid space 5 in the radial direction. The fluid communication portion 601 is formed at each lower side end 64 of the baffle plate 6. As shown in FIGS. 4 and 5, a circular forward-end space 55 is formed through the fluid communication portions 601 at a lower end of the fluid space 5 so as to surround the forward end 24 of the injector 2. The cooling water can flow through the circular forward-end space 55 in a direction around the center axis line L1 of the injector 2 (that is, in the circumferential direction) along its entire circumference.

In FIG. 6, a line 201 indicates a temperature change at the forward end 24 of the injector 2 with respect to the opening area of the fluid communication portion 601, while a line 202 indicates a change of pressure loss of the cooling adapter 1 with respect to the opening area of the fluid communication portion 601.

A flow speed of the cooling water passing through the fluid communication portion 601 is more increased, as the opening area becomes smaller. As shown by the line 201, the temperature at the forward end 24 of the injector 2 can be decreased, when the opening area is made smaller. On the other hand, the pressure loss of the cooling adapter 1 becomes larger, as the opening area becomes smaller. When the pressure loss becomes larger, it is necessary to make larger a size of a pump for supplying the cooling water, or a pumping power of the pump for supplying the cooling water becomes insufficient and the cooling performance may be thereby decreased.

As above, the temperature at the forward end 24 of the injector 2 and the pressure loss of the cooling adapter 1, with respect to the opening area of the fluid communication portion 601, have a trade-off relationship with each other. The opening area of the fluid communication portion 601 is so decided as to satisfy both of an acceptable value (an upper limit) for the temperature at the forward end 24 of the injector 2 and an acceptable value (an upper limit) for the pressure loss of the cooling adapter 1.

In FIG. 6, a line 203 shows the acceptable value for each of the temperature at the forward end 24 of the injector 2 and the pressure loss of the cooling adapter 1. The opening area of the fluid communication portion 601 is set at a value in a range between S1 and S2, wherein the value S1 corresponds to an intersection between the line 203 for the acceptable value (hereinafter, the acceptable-value line 203) and the line 202 for the pressure loss of the cooling adapter 1, while the value S2 corresponds to another intersection between the acceptable-value line 203 and the line 201 for the temperature change at the forward end 24 of the injector 2. An opening area S3 of the fluid communication portion 601, which corresponds to an intersection between the line 201 and the line 202, is a most appropriate opening area. Therefore, when the opening area of the fluid communication portion 601 is set at the value S3, it is possible to make each of the temperature at the forward end 24 and the pressure loss of the cooling adapter 1 at such a value, which is smaller than the acceptable-value line 203 by a certain amount.

The baffle plate 6 can be made of any kind of material. For example, the baffle plate 6 is made of metal, such as, stainless steel (SUS). Alternatively, the baffle plate 6 is made of resin material.

Each of the packing 71 and the seal member 72 is formed in an annular shape and arranged in the accommodation space 41 in such a way that each inner peripheral surface of the packing 71 and the seal member 72 is in contact with the outer peripheral surface of the injector 2 and each outer peripheral surface of the packing 71 and the seal member 72 is in contact with the inner peripheral surface of the body member 4. In other words, the injector 2 is located in each inside space of the packing 71 and the seal member 72. The packing 71 is located at a downstream side of the accommodation space 41, that is, at a position directly above the forward end projection 42 of the body member 4. The seal member 72 is located at an upstream side of the accommodation space 41, that is, at a position separated from the packing 71 in the axial direction.

The packing 71 is a member for transmitting the heat of the injector 2 to the body member 4 cooled down by the cooling water, when the injector 2 and the body member 4 are tightly connected to each other via the packing 71. In addition, the packing 71 has a function of a sealing part for preventing the exhaust gas from leaking out to an outside of the injector 2. The packing 71 is made of, for example, graphite.

The seal member 72 is a member for preventing the exhaust gas from leaking out to the outside of the injector 2. The seal member 72 is made of elastic material, such as, rubber. Alternatively, the seal member 72 is made of metal, such as, cupper or the like.

The outer fixing member 8 fixes the cooling adapter 1, which is composed of the cover member 3, the body member 4 and so on, to the exhaust pipe 110. The outer fixing member 8 has a cylindrical portion 81 and an outwardly extending portion 82 extending from the cylindrical portion 81 in a radial-outward direction. The cover member 3 is inserted through an inside of the cylindrical portion 81 and the cover member 3 is firmly fixed to the cylindrical portion 81 by welding or the like.

A cylindrical fixing projection 111 (FIG. 1) is formed in the exhaust pipe 110 in such a way that the cylindrical fixing projection 111 extends from an outer wall of the exhaust pipe 110 in a radial-outward direction thereof, for example, in the vertical direction. An inside of the cylindrical fixing projection 111 is communicated to the inside of the exhaust pipe 110. An outwardly extending portion 112 is formed at a forward end of the cylindrical fixing projection 111 in such a way that the outwardly extending portion 112 extends from the cylindrical fixing projection 111 in a radial-outward direction thereof. The outwardly extending portion 82 of the outer fixing member 8 is located on the outwardly extending portion 112 and both of the outwardly extending portions 82 and 112 are connected to each other by a connecting member 113.

Since an inside of the outer fixing member 8 is communicated to the inside of the exhaust pipe 110, the forward end 24 of the injector 2 is exposed to the inside of the exhaust pipe 110. Each of the inlet port 51 and the outlet port 52 is provided at a position axially outside of the outer fixing member 8, that is, at a position outside of the exhaust pipe 110.

An operation and advantages of the present embodiment will be explained. The cooling water having entered the fluid space 5 through the inlet port 51 flows in the inlet-side fluid space 53 in the axial direction to the bottom portion 32 (in a downward direction) and then flows in the circular forward-end space 55 in the circumferential direction thereof through the fluid communication portions 601. The cooling water further flows in the outlet-side fluid space 54 in the axial direction to the upper-side cylindrical portion 43 (in an upward direction) and flows out of the fluid space 5 through the outlet port 52. In FIGS. 1, 4 and 5, flow directions of the cooling water are indicated by arrows.

As above, the cooling water is guided by the baffle plates 6 to the circular forward-end space 55, while the cooling water flows only in the inlet-side fluid space 53 until reaching the circular forward-end space 55. Since the inlet-side fluid space 53 is a part of the fluid space 5 in the circumferential direction, it is possible to suppress heat exchange between the cooling water and the cover member 3, which is in contact with the exhaust gas and thereby temperature of which is high. As above, it is possible to supply the cooling water, a temperature increase of which is suppressed, to the circular forward-end space 55 and to thereby effectively cool down the forward end 24 of the injector 2 via the body member 4.

In addition, since an entire area of the circular forward-end space 55 is communicated to the inlet-side and the outlet-side fluid spaces 53 and 54 in the circumferential direction, it is possible to generate the fluid flow of the cooling water in the entire area in the circumferential direction. It is, therefore, possible to evenly cool down the forward end 24 of the injector 2.

According to the above first prior art (JP 5,863,981), the multiple openings are formed at the lower-side end of the guide member and the outside fluid space is communicated to a forward end area of the inside fluid space surrounding the forward end portion of the fluid injection valve through the multiple openings. It is anticipated that flow speed of the cooling water in a part of the forward end portion other than the openings is relatively small. As a result, there exists a portion in the forward end portion of the fluid injection valve, for which the forward end is not evenly cooled down.

In the present embodiment, each of the inlet port 51 and the outlet port 52 is formed in the respective fluid spaces 53 and 54 separated in the circumferential direction. The fluid communication portions 601 formed by the baffle plates 6 are located at the lower-side positions axially opposite to the inlet and the outlet ports 51 and 52. Therefore, it is possible that the cooling water flows in the fluid space 5 in the axial direction. When compared with a case, in which no baffle plate is provided, it is possible in the present embodiment to elongate a flow passage of the cooling water in the fluid space 5. It is thereby possible to effectively cool down the body member 4 and the injector 2, which is arranged inside of the body member 4.

In the case that the baffle plates are not formed, the cooling water directly flows from the inlet port 51 to the outlet port 52 after the fluid space 5 is filled with the cooling water. The cooling water stays in an area of the fluid space 5 adjacent to the forward end of the injector 2 for a longer period. It is, therefore, difficult to effectively cool down the forward end 24 of the injector 2.

As shown in FIG. 3, since the inner side end 62 of the baffle plate 6 is in contact with the body member 4, it is possible to cool down the body member 4 via the baffle plates 6. In other words, it is possible to more effectively cool down the injector 2.

In the present embodiment, each of the baffle plates 6 is made of the flat plate, which can be easily manufactured. In the above first prior art (JP 5,863,981), the guide member is formed in a cylindrical shape and the multiple openings are formed at the lower-side end of the guide member. The guide member of the first prior art is more difficult to manufacture, when compared with the baffle plate 6 of the present embodiment.

### Second Embodiment

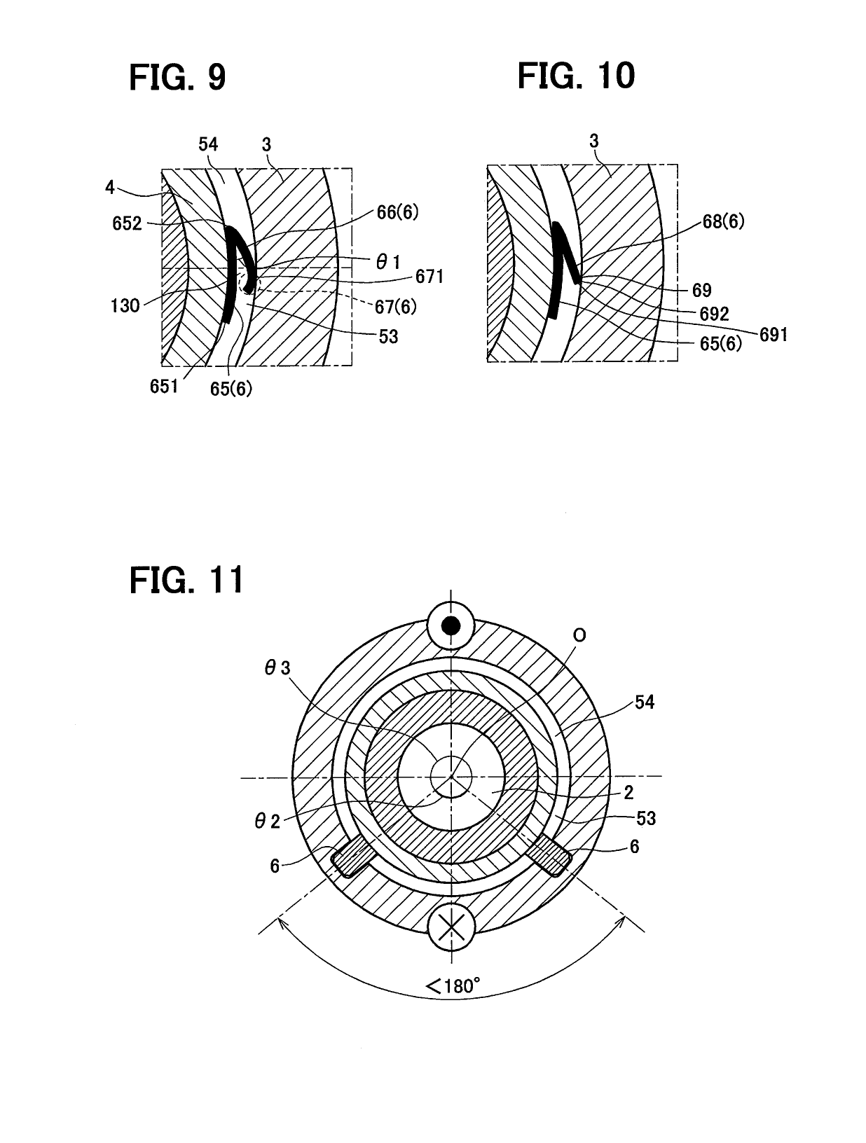

Next, a second embodiment of the present disclosure will be explained by focusing on those portions different from the first embodiment. As shown in FIGS. 8 and 9, the partitioning wall 6 (the baffle plate 6) is different from that of the first embodiment. Each of the baffle plates 6 is composed of an inside plate portion 65 and an outside plate portion 66, when viewed it in a cross section on a plane perpendicular to the center axis line L1 of the injector 2. The inside plate portion 65 extends in the circumferential direction of the injector 2 around its center position “◯” (that is, in the circumferential direction of the body member 4) and is in contact with the outer peripheral surface of the body member 4. More exactly, the inside plate portion 65 is in contact with the body member 4 at its entire inner surface opposing to the outer peripheral surface of the body member 4. In other words, the inside plate portion 65 and the body member 4 are in a surface-to-surface contact with each other.

The outside plate portion 66 is connected to a circumferential end 652 of the inside plate portion 65, wherein the circumferential end 652 is located on a side of the outlet-side fluid space 54. The circumferential end 652 is also referred to as an outlet-side circumferential end 652, while another circumferential end 651 of the inside plate portion 65 is referred to as an inlet-side circumferential end 651. A circumferential end 67 of the outside plate portion 66, which is on a side opposite to another circumferential end of the outside plate portion 66 connected to the outlet-side circumferential end 652, is referred to as a forward end portion 67. The outside plate portion 66 extends in the circumferential direction from the outlet-side circumferential end 652 to the inlet-side circumferential end 651 and in a radial-outward direction from the body member 4 to the cover member 3. A part of the forward end portion 67 is in contact with the inner peripheral surface of the cover member 3. As shown in FIGS. 8 and 9, the baffle plate 6 is formed in a V-letter shape in the cross section on the plane perpendicular to the center axis line L1 of the injector 2. The outside plate portion 66 is located at a radial-outside position of the inside plate portion 65, that is, in a radial direction of a circle having a center at the center position “◯”. The outside plate portion 66 and the inside plate portion 65 are formed in the V-letter shape having a angle “θ1” smaller than 90 degrees (that is, an acute angle).

A bent portion 671 is formed in the outside plate portion 66 at a position close to the forward end portion 67, so that the forward end portion 67 is inwardly bent and pointed to the inside plate portion 65 and the bent portion 671 is in contact with the inner peripheral surface of the cover member 3. In other words, the outside plate portion 66 is not in contact with the cover member 3, except for the bent portion 671.

The inside plate portion 65 and the outside plate portion 66 of the baffle plate 6 are made of a single plate member by bending the same. The baffle plate 6 is interposed in the fluid space 5 between the body member 4 and the cover member 3 in such a way that a spring force acts on the inside and the outside plate portions 65 and 66 in a direction increasing the angle “θ1” formed between them. A larger spring force is more preferable.

A radial space 130 is formed between the inside plate portion 65 and the outside plate portion 66 of the V-shaped baffle plate 6. The radial space 130 is formed on a side of the inlet-side fluid space 53. Each of the inside plate portion 65 and the outside plate portion 66 extends in the axial direction of the center axis line L1 of the injector 2, that is, in a direction perpendicular to a sheet of FIG. 8 or FIG. 9, in a similar manner to the baffle plate 6 of the first embodiment. The baffle plate 6 is fixed to the cover member 3 and/or the body member 4 by any suitable manner. For example, the inside plate portion 65 is fixed to the body member 4 by the welding.

Since the baffle plate 6 of the present embodiment is in contact with the cover member 3 at the bent portion 671, the baffle plate 6 and the cover member 3 are in a line contact with each other in the axial direction along the center axis line L1 of the injector 2. According to such a structure of the present embodiment, a contacting area between the baffle plate 6 and the cover member 3 can be made smaller than that of a case of the surface-to-surface contact. It is possible to suppress the heat transfer of the high-temperature cover member 3 to the body member 4 and/or the injector 2 via the baffle plate 6. It is, therefore, possible to improve the cooling performance of the injector 2. In addition, it is possible to increase a contact pressure as a result that the contact area between the baffle plate 6 and the cover member 3 is made smaller. In other words, it is possible to improve a sealing performance between the baffle plate 6 and the cover member 3 and to thereby suppress the leakage of the cooling water through a clearance between the baffle plate 6 and the cover member 3.

In addition, since the baffle plate 6 is located in the condition that the spring force acts on the baffle plate 6 so as to push the same in the radial direction to the cover member 3, it is possible to further improve the sealing performance between the baffle plate 6 and the cover member 3. Furthermore, since the radial space 130 is located in the inlet-side fluid space 53, the fluid pressure of which is higher than that in the outlet-side fluid space 54, it is possible to apply a pressure difference between the inlet-side and the outlet-side fluid spaces 53 and 54 to the outside plate portion 66, more exactly, to the inner surface of the outside plate portion 66 facing to the inside plate portion 65. As a result, it is possible to increase a pushing force of the bent portion 671 in the radial direction to the cover member 3, to thereby further increase the sealing performance between the baffle plate 6 and the cover member 3.

### Third Embodiment

In the second embodiment shown in FIG. 9, the bent portion 671 is formed at the portion close to the forward end 67 of the outside plate portion 66.

However, the baffle plate 6 can be formed in a shape, as shown in FIG. 10. The baffle plate 6 has the inside plate portion 65 and an outside plate portion 68, as in the same manner to the second embodiment. The inside plate portion 65 has the same shape to that of the second embodiment of FIG. 9. In the third embodiment, the outside plate portion 68 and a forward end portion 69 are different from those of the second embodiment of FIG. 9.

In the third embodiment, as shown in FIG. 10, no bent portion is formed in the outside plate portion 68 so that the forward end portion 69 is formed in a straightly extending shape. An end surface 691 at the forward end portion 69 is inclined with respect to the inner peripheral surface of the cover member 3. Only an edge portion 692 at the end surface 691 is in contact with the inner peripheral surface of the cover member 3.

As above, in the present embodiment, the baffle plate 6 and the cover member 3 are in contact with each other at the edge portion 692 formed at the forward end portion 69 of the straightly extending plate shape. The same advantages to those of the second embodiment can be obtained in the third embodiment.

### Fourth Embodiment

Next, a fourth embodiment of the present disclosure will be explained by focusing on those portions different from the first embodiment. In the first embodiment, for example, as shown in FIG. 3, the baffle plates 6 are located at such positions, which are opposed to each other in the radial direction on the straight line passing over the center position “◯” of the injector 2.

However, according to the fourth embodiment, as shown in FIG. 11, an angle “θ2” formed at the center position “◯” of the injector 2 between the baffle plates 6 in the inlet-side fluid space 53 is made smaller than 180 degrees. In the present embodiment, an angle “θ3” formed at the center position “◯” between the baffle plates 6 in the outlet-side fluid space 54 is larger than 180 degrees.

According to the above structure of the fourth embodiment, it is possible to make smaller a contact surface area between a wall surface of the inlet-side fluid space 53 and the cooling water. It is thereby possible to further suppress a temperature increase of the cooling water during the movement of the cooling water to the circular forward-end space 55, which surrounds the forward end 24 of the injector 2. In addition, since a cross sectional area of the inlet-side fluid space 53 on the plane perpendicular to the center axis line L1 of the injector 2 becomes smaller, it is possible to increase the flow speed of the cooling water in the inlet-side fluid space 53. Accordingly, it is possible to further effectively cool down the forward end 24 of the injector 2.

### Fifth Embodiment

Next, a fifth embodiment of the present disclosure will be explained by focusing on those portions different from the first embodiment. In the above embodiments, the baffle plate 6 is arranged in the fluid space 5 in such a way that an angle of the baffle plate 6 with respect to the center axis line L1 of the injector 2 is 0 (zero) degree.

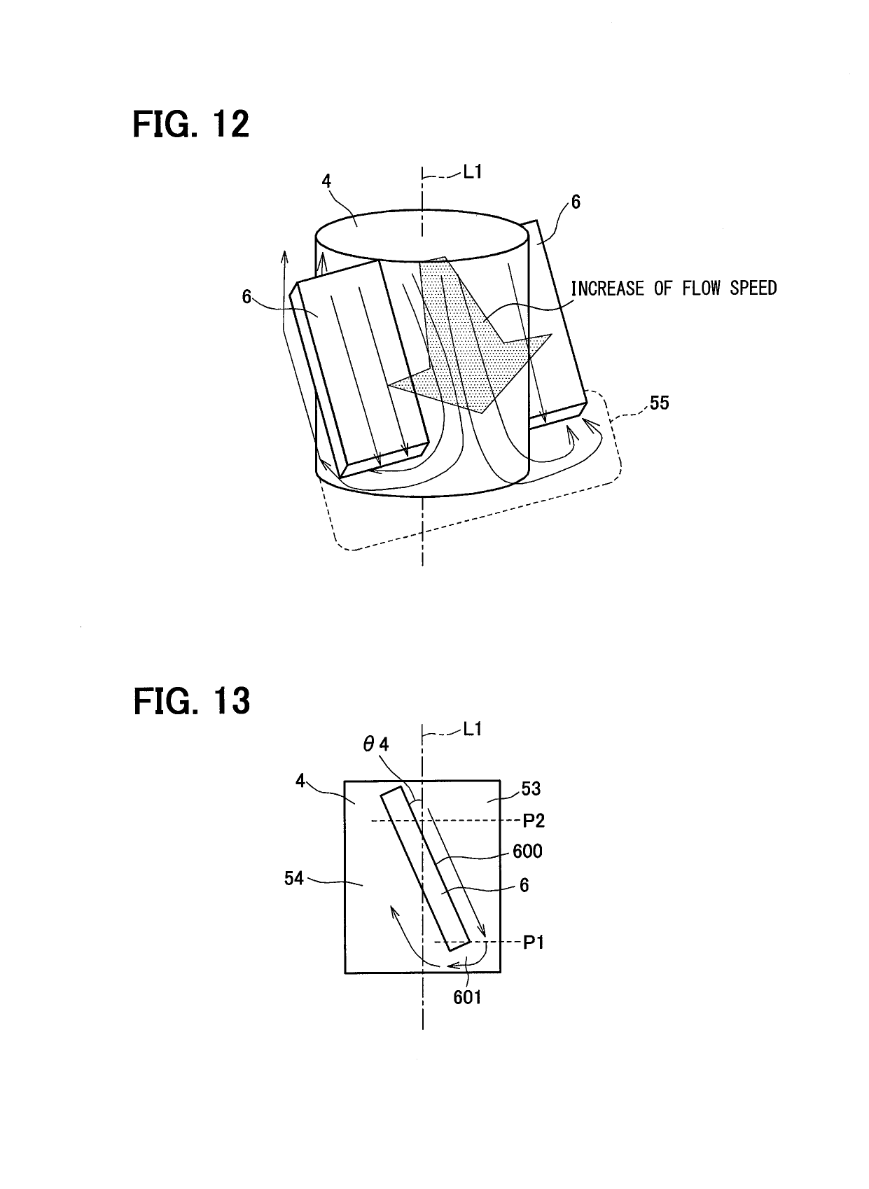

According to the present embodiment, as shown in FIGS. 12 and 13, the baffle plate 6 is arranged in the fluid space 5 so as to be inclined with respect to the center axis line L1 of the injector 2. More exactly, the baffle plate 6 is inclined with respect to the center axis line L1 in such a direction that a cross sectional area of the inlet-side fluid space 53 on the plane perpendicular to the center axis line L1 at a downstream side point P1 is smaller than a cross sectional area of the inlet-side fluid space 53 on the plane perpendicular to the center axis line L1 at an upstream side point P2. As shown in FIG. 13, the downstream side point P1 is located at a portion of the baffle plate 6 close to the fluid communication portion 601.

As shown in FIGS. 12 and 13, the entire portion of the baffle plate 6 is inclined by a constant angle with respect to the center axis line L1. In other words, an angle “θ4” (other than zero degree) formed between the side surface 600 of the baffle plate 6 and the center axis line L1 is constant at any points of the baffle plate 6 in the axial direction. The baffle plate 6 can be fixed to the body member 4 and/or the cover member 3 in any suitable manner. For example, the baffle plate 6 is fixed to the body member 4 by the welding.

In FIGS. 12 and 13, flow directions of the cooling water are indicated by arrows. Since, in the present embodiment, the cross sectional area of the inlet-side fluid space 53 at the downstream side point P1 is smaller than that at the upstream side point P2, it is possible to increase the flow speed of the cooling water passing through the fluid communication portion 601, which is formed below the downstream side point P1. As a result, the cooling water circulates at a high speed in the circular forward-end space 55 surrounding the forward end 24 of the injector 2, to thereby effectively cool down the forward end 24 of the injector 2. The cooling water upwardly flows in the outlet-side fluid space 54 after circulating in the circular forward-end space 55 and flows out of the fluid space 5 from the outlet port 52.

### Sixth Embodiment

In the above embodiment shown in FIGS. 12 and 13, the entire portion of the baffle plate 6 is inclined with respect to the center axis line L1 of the injector 2.

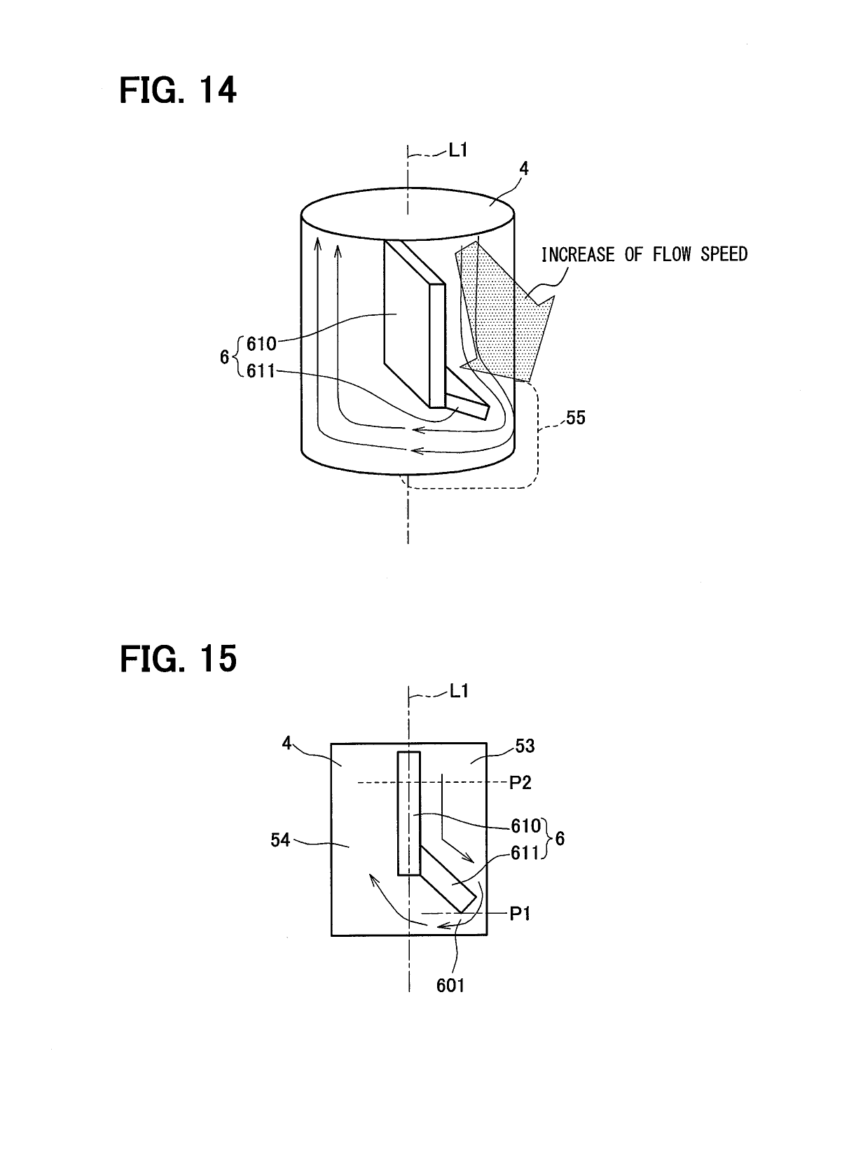

In the present embodiment, as shown in FIGS. 14 and 15, a part (a forward end portion 611) of the baffle plate 6 is inclined with respect to the center axis line L1 of the injector 2. More exactly, the baffle plate 6 has a first part 610 which straightly extends in the axial direction (an angle between the first part 610 and the center axis line L1 is 0 (zero) degree) and a second part 611 (the forward end portion 611) which is inclined in the direction to the inlet-side fluid space 53. The second part 611 extends from a lower end of the first part 610 (an end on a side to the circular forward-end space 55) in a right-hand and downward direction in FIG. 15.

In addition, the second part 611 of the baffle plate 6 is inclined in the direction so that a cross sectional area of the inlet-side fluid space 53 on the plane perpendicular to the center axis line L1 at the downstream side point P1 (that is, the cross sectional area formed by the second part 611) is smaller than a cross sectional area of the inlet-side fluid space 53 on the plane perpendicular to the center axis line L1 at the upstream side point P2 (that is, the cross sectional area formed by the first part 610). As shown in FIG. 15, the downstream side point P1 is located at the second part 611 of the baffle plate 6 close to the fluid communication portion 601. Each of the first part 610 and the second part 611 of the baffle plate 6 can be made by bending one single plate member. Alternatively, each of them is separately made and welded to each other.

In FIGS. 14 and 15, flow directions of the cooling water are indicated by arrows. In the present embodiment, the cross sectional area of the inlet-side fluid space 53 at the downstream side point P1 is smaller than that at the upstream side point P2, in a similar manner to that of the fifth embodiment. The same advantages to those of the fifth embodiment can be obtained in the present embodiment.

### Seventh Embodiment

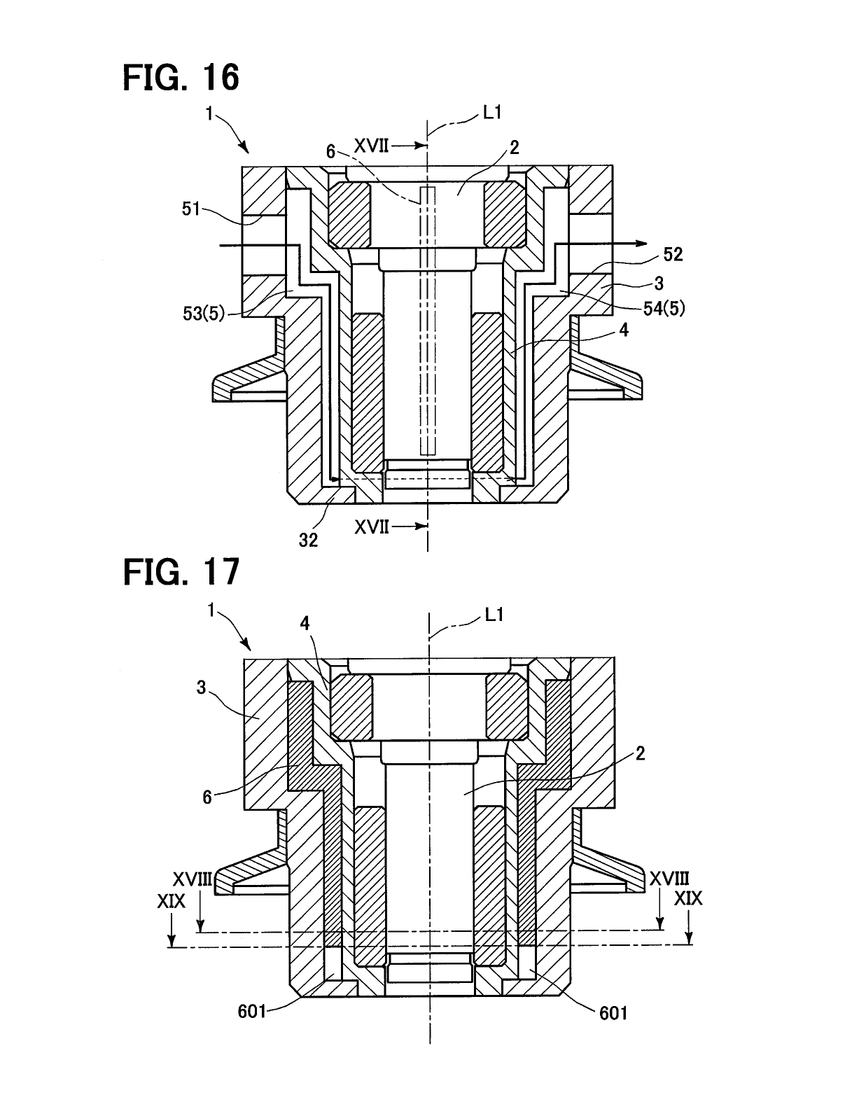

Next, a seventh embodiment of the present disclosure will be explained with reference to FIGS. 16 to 20, by focusing on those portions different from the first embodiment.

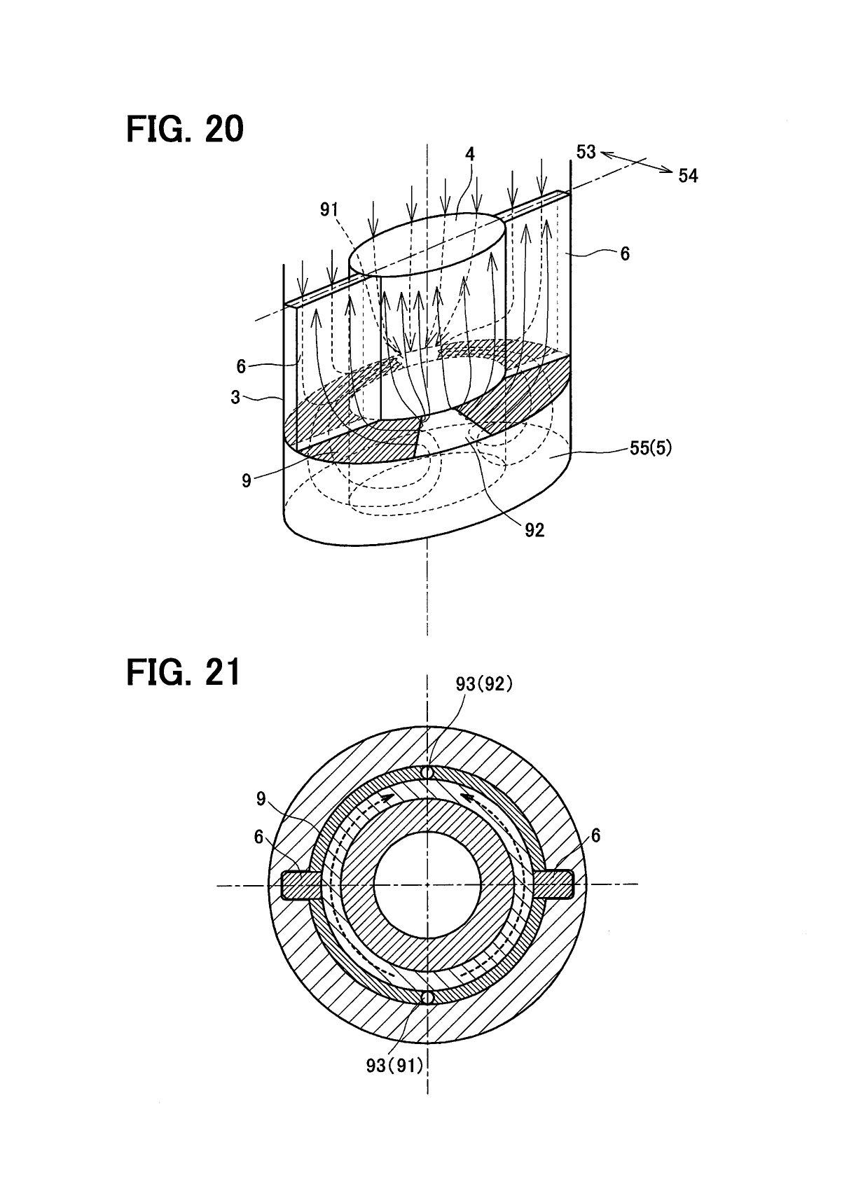

According to the present embodiment, as shown in FIGS. 19 and 20, the cooling adapter 1 (the cover member 3 and the body member 4) has a second baffle plate 9 in addition to the baffle plate 6 (hereinafter, the first baffle plate 6 or the first partitioning wall 6). The structure of the seventh embodiment except for the second baffle plate 9 is the same to that of the first embodiment.

The second baffle plate 9 is provided in the fluid space 5 at a boundary between the circular forward-end space 55 surrounding the forward end 24 of the injector 2 and a remaining fluid space 56 of the fluid space 5 (the inlet-side and the outlet-side fluid spaces 53 and 54). The second baffle plate 9 extends in the circumferential direction around the center position “◯” of the injector 2. In other words, the second baffle plate 9 extends from a lower-side end of the first baffle plate 6 (which extends in the axial direction) in the circumferential direction of the injector 2.

The second baffle plate 9 has an opening 91 for the inlet-side fluid space 53 and another opening 92 for the outlet-side fluid space 54, so that each of the inlet-side and the outlet-side fluid spaces 53 and 54 is respectively communicated to the circular forward-end space 55 through each of the openings 91 and 92. The opening 91 provided for the inlet-side fluid space 53 is referred to as a first opening 91, while the other opening 92 provided for the outlet-side fluid space 54 is referred to as a second opening 92. The first opening 91 and the second opening 92 are formed at positions, which are symmetric to each other with respect to the center position “◯” of the injector 2, as shown in FIG. 19.

In the embodiment shown in FIG. 19, each of the openings 91 and 92 is formed at a position, which corresponds to a middle point between the first baffle plates 6 in the circumferential direction around the center position “◯”. However, the first and the second openings 91 and 92 can be formed at any positions other than the middle points. For example, each of the first and the second openings 91 and 92 may be provided at positions, which are on a line R2 passing through the center position “◯”, wherein an angle between a line R1 connecting the first baffle plates 6 to each other and the line R2 is an angle other than 90 degrees (smaller than 90 degrees). Accordingly, the first and the second openings 91 and 92 are arranged in a symmetrical manner with respect to the center position “◯”, when they are formed on the points of the line R2.

The second baffle plate 9 is composed of four divided plate portions (a first to a fourth plate portions) 9a to 9d, as shown in FIG. 19. Each of the plate portions 9a to 9d is formed in an arc shape. The first and the second plate portions 9a and 9b are provided in the inlet-side fluid space 53, while the third and the fourth plate portions 9c and 9d are provided in the outlet-side fluid space 54.

The first plate portion 9a of the second baffle plate 9 is located in the inlet-side fluid space 53 in such a way that one of circumferential ends of the first plate portion 9a (a left-hand side end in FIG. 19) is in contact with, or is opposing with a small gap to, a circumferential side surface or an axial end surface of a first plate portion 600a of the first baffle plate 6. The other circumferential end of the first plate portion 9a (a right-hand side end in FIG. 19) is located at a position separated from one circumferential end of the second plate portion 9b (a left-hand side end in FIG. 19) in the circumferential direction. The other circumferential end of the second plate portion 9b (a right-hand side end in FIG. 19) is in contact with, or is opposing with a small gap to, a circumferential side surface or an axial end surface of a second plate portion 600b of the first baffle plate 6. The first opening 91 is formed and surrounded by the right-hand side end of the first plate portion 9a, the left-hand side end of the second plate portion 9b, the inner peripheral surface of the cover member 3 between the first and the second plate portions 9a and 9b, and the outer peripheral surface of the body member 4 between the first and the second plate portions 9a and 9b.

In a similar manner to the first and the second plate portions 9a and 9b, the third plate portion 9c is located in the outlet-side fluid space 54 in such a way that one of circumferential ends of the third plate portion 9c (a left-hand side end in FIG. 19) is in contact with, or is opposing with a small gap to, another circumferential side surface or the axial end surface of the first plate portion 600a of the first baffle plate 6. The other circumferential end of the third plate portion 9c (a right-hand side end in FIG. 19) is located at a position separated from one circumferential end of the fourth plate portion 9d (a left-hand side end in FIG. 19) in the circumferential direction. The other circumferential end of the fourth plate portion 9d (a right-hand side end in FIG. 19) is in contact with, or is opposing with a small gap to, another circumferential side surface or the axial end surface of the second plate portion 600b of the first baffle plate 6. The second opening 92 is formed and surrounded by the right-hand side end of the third plate portion 9c, the left-hand side end of the fourth plate portion 9d, the inner peripheral surface of the cover member 3 between the third and the fourth plate portions 9c and 9d, and the outer peripheral surface of the body member 4 between the third and the fourth plate portions 9c and 9d.

The first plate portion 9a and the third plate portion 9c may be formed as one integral part, while the second plate portion 9b and the fourth plate portion 9d may be likewise formed as one integral part. In other words, the second baffle plate 9 may be composed of a pair of C-letter shaped plate portions.

Alternatively, the second baffle plate 9 may be made of one single member, which is formed in an annular shape entirely extending in the circumferential direction, as shown in FIG. 21. In this case, at least two through-holes 93 are formed in the second baffle plate 9 at positions, respectively corresponding to the inlet-side and the outlet-side fluid spaces 53 and 54, so as to form the first and the second openings 91 and 92 for communicating the circular forward-end space 55 to each of the inlet-side and the outlet-side fluid spaces 53 and 54. A number of the through-holes 93 is not limited to the two.

When an opening area of the first and/or the second openings 91 and 92 is too small relative to a passage area of the circular forward-end space 55, a pressure loss becomes larger. Therefore, it is preferable that each opening area of the first and the second openings 91 and 92 is made to be larger than the passage area of the circular forward-end space 55, more exactly, larger than a passage area formed by the fluid communication portion 601 (FIG. 5).

The second baffle plate 9 can be fixed to any part of the fluid-space forming unit (the body member 4, the cover member 3 and/or the first baffle plate 6) in any suitable fixing manner. For example, the second baffle plate 9 is fixed to the first baffle plate 6 by the welding. An outer peripheral end 941 (FIG. 19) of the second baffle plate 9 is in contact with the inner peripheral surface of the cover member 3. Alternatively, the outer peripheral end 941 may be separated from the inner peripheral surface of the cover member 3 with a small gap. In a similar manner, an inner peripheral end 942 (FIG. 19) of the second baffle plate 9 is in contact with the outer peripheral surface of the body member 4. Alternatively, the inner peripheral end 942 may be separated from the outer peripheral surface of the body member 4 with a small gap.

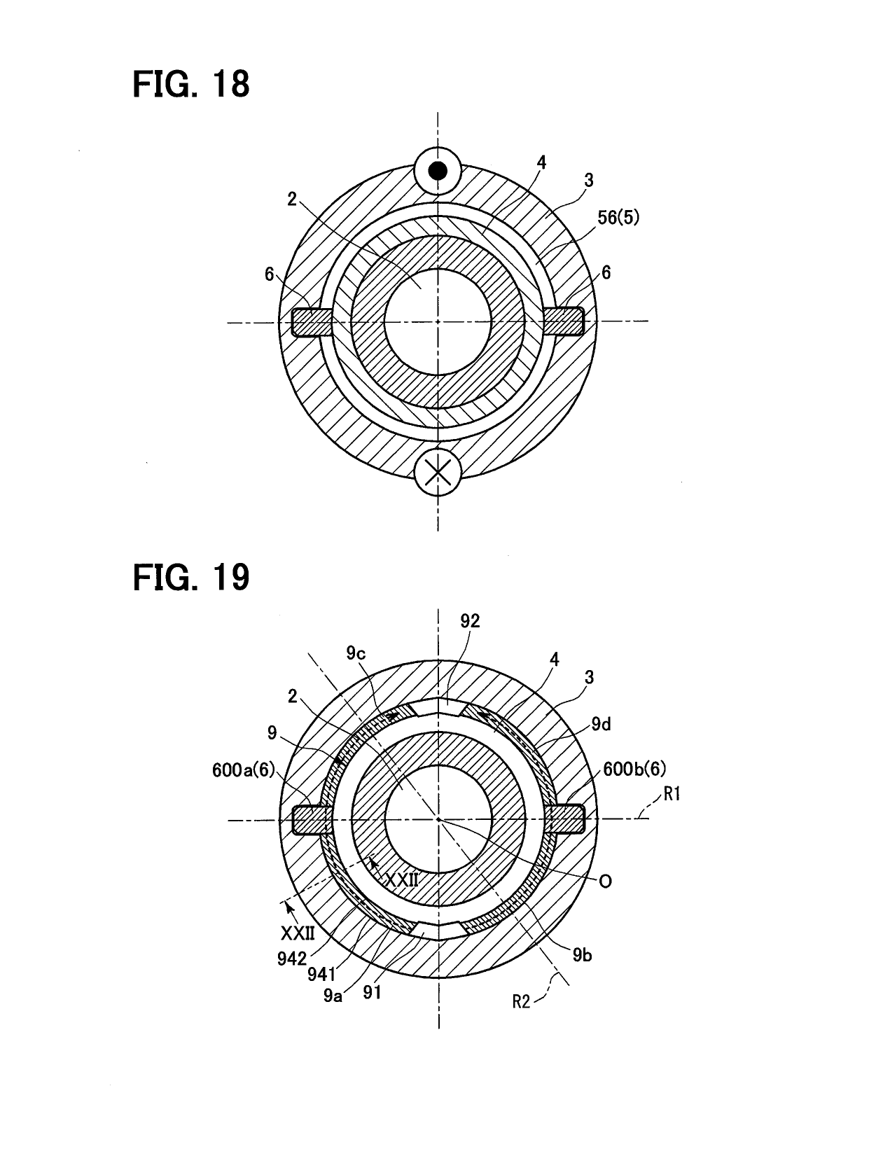

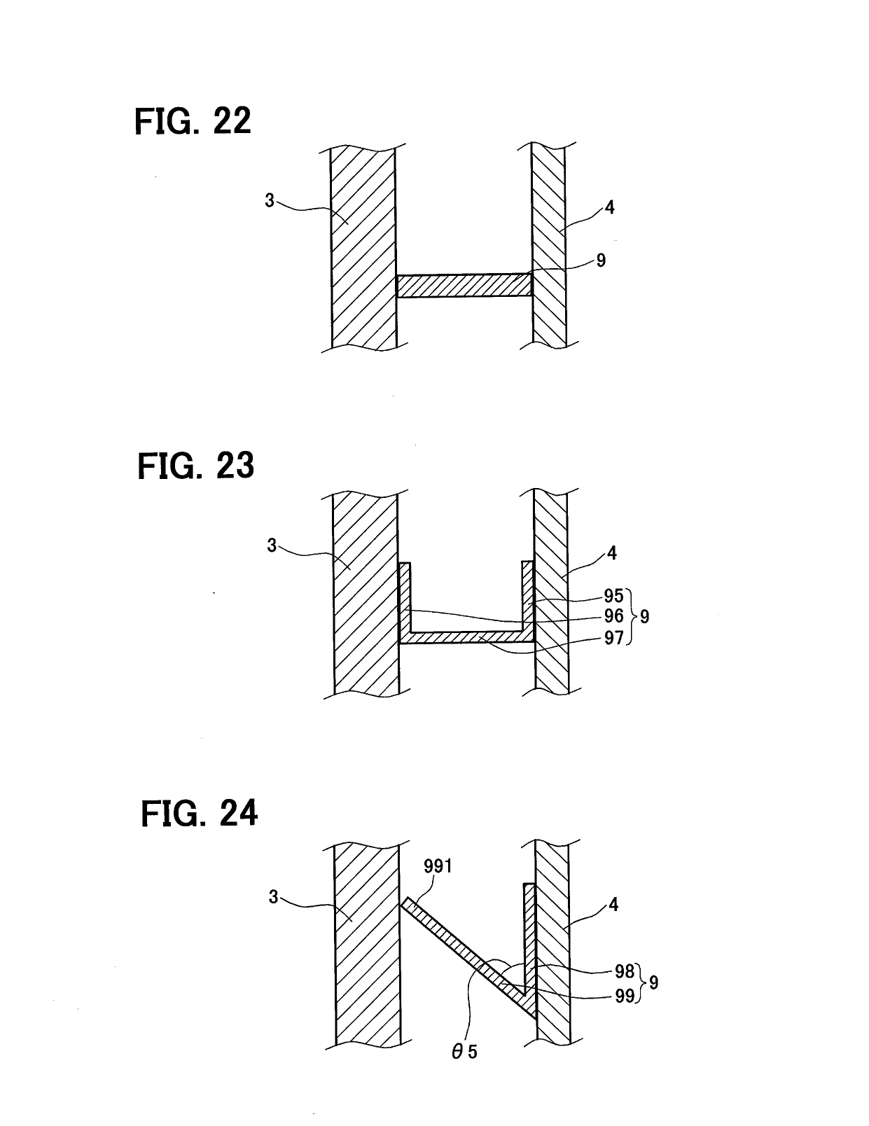

In the present embodiment, a cross sectional shape of the second baffle plate 9 on the plane parallel to the center axis line L1 of the injector 2 (that is, on the plane perpendicular to the drawing sheet of FIG. 18) is a straightly extending flat shape as shown in FIG. 22. Alternatively, the second baffle plate 9 may have a cross sectional shape of a U-letter configuration, as shown in FIG. 23. In the example of FIG. 23, the second baffle plate 9 has a body-side plate portion 95 extending along the outer peripheral surface of the body member 4, a cover-side plate portion 96 extending along the inner peripheral surface of the cover member 3, and a connecting plate portion 97 formed between them. The body-side plate portion 95 is in contact with the body member 4. The cover-side plate portion 96 is in contact with the cover member 3. The connecting plate portion 97 connects a lower end of the body-side plate portion 95 with a lower end of the cover-side plate portion 96. Alternatively, the connecting plate portion 97 connects the body-side and the cover-side plate portions 95 and 96 at any other portions than the lower ends thereof.

Alternatively, the second baffle plate 9 may be formed in a V-letter shape, like the second embodiment shown in FIGS. 9 and 10, so that the second baffle plate 9 has a spring force for pushing the cover member 3 in the radial-outward direction. More exactly, as shown in FIG. 24, the second baffle plate 9 has a body-side plate portion 98 extending along the outer peripheral surface of the body member 4 and a cover-side plate portion 99 extending from one of axial ends (a lower end) of the body-side plate portion 98 in a direction to the cover member 3. The cover-side plate portion 99 is inclined with respect to the inner peripheral surface of the cover member 3. An edge of a forward end portion 991 of the cover-side plate portion 99 is in contact with the cover member 3. The spring force acts on the cover-side plate portion 99 in such a way that an angle “θ5” formed between the body-side plate portion 98 and the cover-side plate portion 99 is increased.

According to the above structure, the cover member 3 having high temperature and the second baffle plate 9 are in a line contact with each other in the circumferential direction. Since a contacting area between the cover member 3 and the second baffle plate 9 can be made smaller, it is possible to suppress the heat transfer from the cover member 3 to the body member 4 and/or the injector 2 via the second baffle plate 9. In addition, as a result of the line contact between the cover member 3 and the second baffle plate 9, it is possible to improve a sealing performance between the cover member 3 and the second baffle plate 9. In addition, since the second baffle plate 9 is located in the condition that the spring force acts on the second baffle plate 9 so as to push the same in the direction to the cover member 3, it is possible to further improve the sealing performance between the cover member 3 and the second baffle plate 9.

A bent portion may be formed at the forward end portion 991 of the second baffle plate 9, in a similar manner to the second embodiment shown in FIGS. 8 and 9, so that the bent portion of the cover-side plate portion 99 is in contact with the cover member 3.

The second baffle plate 9 can be made of any kind of material. For example, the second baffle plate 9 is made of metal, such as, stainless steel (SUS). Alternatively, the second baffle plate 9 is made of resin material. The second baffle plate 9 is also referred to as a second partitioning wall.

An operation and advantages of the present embodiment will be explained with reference to FIGS. 16, 19 and 20. The cooling water having entered the fluid space 5 through the inlet port 51 flows in the inlet-side fluid space 53 in the axial direction to the bottom portion 32 (in the downward direction in FIG. 16 or 20) and then flows into the circular forward-end space 55 thereof through the first opening 91. The cooling water flows in the circular forward-end space 55 in the circumferential direction thereof to the second opening 92, which is located at the position opposite to the first opening 91 in the radial direction of the injector 2. Then, the cooling water flows into the outlet-side fluid space 54 through the second opening 92. The cooling water further flows in the outlet-side fluid space 54 in the axial-upward direction and flows out of the fluid space 5 through the outlet port 52. In FIGS. 16, 19 and 20, flow directions of the cooling water are indicated by arrows.

According to the above structure and operation, it is possible to intensify the flow of the cooling water in the circumferential direction in the circular forward-end space 55, to thereby effectively cool down the forward end of the body member 4 as well as the forward end 24 of the injector 2, each of which is located inside of the circular forward-end space 55.

In addition, since the first opening 91 and the second opening 92 are located at the positions, which are symmetric with respect to the center axis line L1 of the injector 2, it is possible to evenly cool down the entire portion of the forward end 24 of the injector 2.

### Modifications of First Embodiment

In the first embodiment, each entire portion of the lower end of the baffle plate 6 is separated from the bottom portion 32 of the cover member 3, so that the fluid communication portion 601 is formed in order to communicate the inlet-side and the outlet-side fluid spaces 53 and 54 with each other in the circumferential direction.

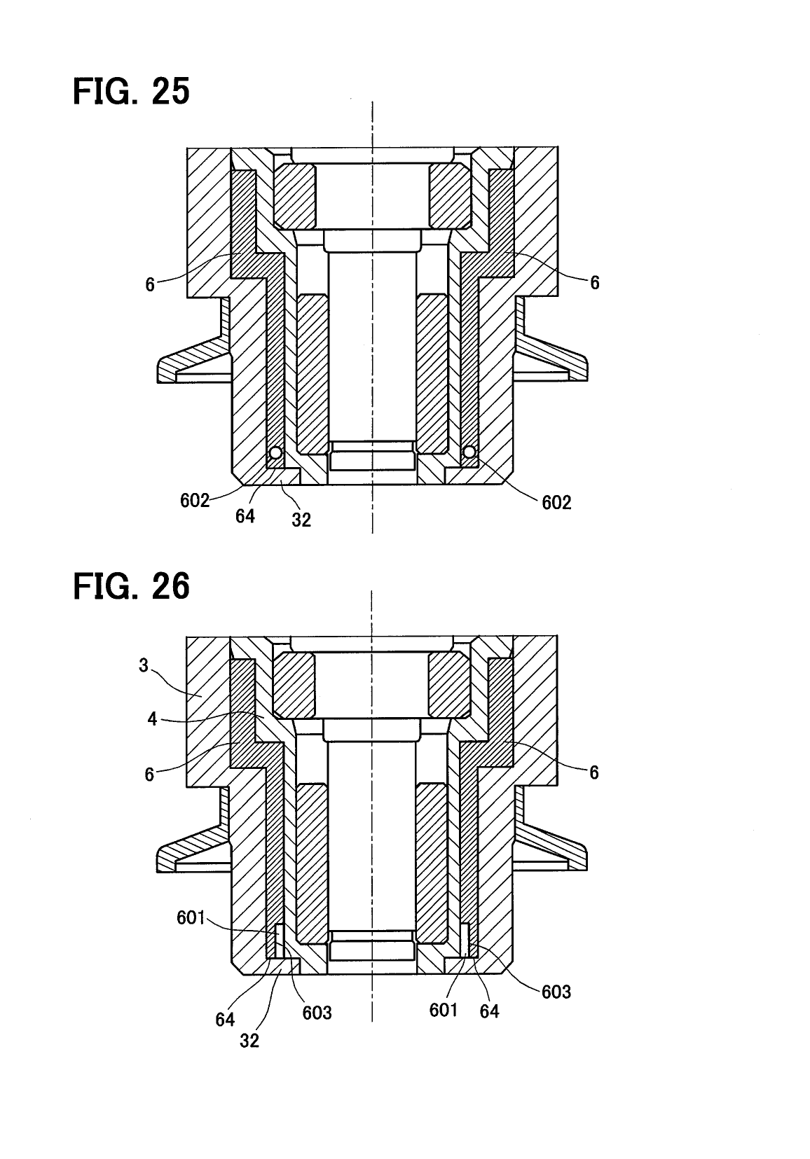

In a modification shown in FIG. 25, however, a through-hole 602 is formed in each of the baffle plates 6 at a position neighboring to the lower side end 64. In addition, the lower side end 64 of the baffle plate 6 is in contact with the bottom portion 32 of the cover member 3. According to the modification, each of the through-holes 602 works as the fluid communication portion (601) for communicating the inlet-side and the outlet-side fluid spaces 53 and 54 in the circumferential direction. A number of the through-hole 602 is not limited to one in each of the baffle plates 6.

In another modification shown in FIG. 26, a notched portion 603 is formed in each of the baffle plates 6 at the lower side end 64 thereof. In addition, the lower side end 64 of the baffle plate 6 is in contact with the bottom portion 32 of the cover member 3. According to the modification of FIG. 26, each of the notched portions 603 likewise works as the fluid communication portion 601 for communicating the inlet-side and the outlet-side fluid spaces 53 and 54 in the circumferential direction.

In the modification of FIG. 26, the fluid communication portion 601 is formed between the notched portion 603 and the outer peripheral surface of the body member 4. However, the notched portion 603 can be formed at such a portion of the baffle plate 6 that the fluid communication portion 601 is formed between the notched portion and the inner peripheral surface of the cover member 3.

In the above embodiments, the present disclosure is applied to the injector 2 for injecting the urea aqueous solution. However, the present disclosure can be applied to any other type of the injectors, which inject fluid other than the urea aqueous solution (for example, unburnt fuel) into the exhaust pipe.

In addition, the first baffle plate 6 may be provided in the fluid space 5 in such a manner that the first baffle plate is separated with a small gap in the radial direction from both of the outer peripheral surface of the body member 4 and the inner peripheral surface of the cover member 3 and that a small amount of the cooling water may flow through the small gap.

In addition, a number of the first baffle plate 6 is not limited to two but more than two baffle plates may be provided. In this case, there are more than two fluid flow areas 53 and 54 arranged in the circumferential direction. Either the inlet port 51 or the outlet port 52 is provided for each of the fluid flow areas. Alternatively, each of the inlet port 51 and the outlet port 52 is provided for each one fluid flow area, while no inlet port and no outlet port is provided for the remaining fluid flow areas. In the case that more than two first baffle plates 6 are provided, the fluid communication portion 601 is provided in each of the first baffle plates, so that the circular forward-end space 55 is formed so as to surround the forward end of the injector.

The present disclosure is not limited to the above embodiments and/or modifications but can be further modified in various manners without departing from a spirit of the present disclosure. In addition, the above embodiments and/or modifications can be combined to each other.

### Eighth Embodiment

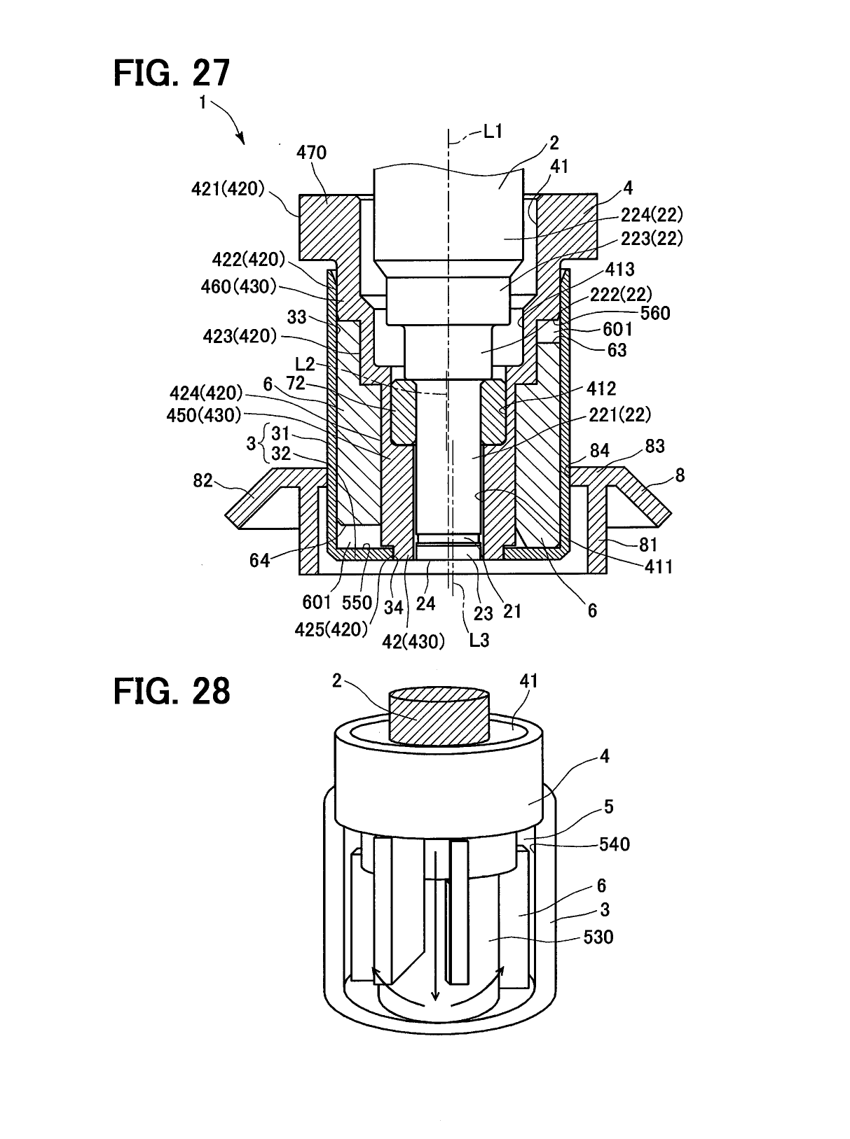

In an eighth embodiment, as shown in FIG. 27, the injector housing 22 is formed in such a shape that an outer diameter is changed in a stepwise manner along the center axis line L1 of the injector 2. More exactly, in the axial direction of the injector 2 from the downstream side to the upstream side, the injector housing 22 is composed of a first cylindrical portion 221, a second cylindrical portion 222 having a larger diameter than that of the first cylindrical portion 221, a third cylindrical portion 223 having a larger diameter than that of the second cylindrical portion 222, and a fourth cylindrical portion 224 having a larger diameter than that of the third cylindrical portion 223. The first to the fourth cylindrical portions 221 to 224 are coaxially formed with one another. A step portion is formed at each boundary between the neighboring cylindrical portions 221 to 224.

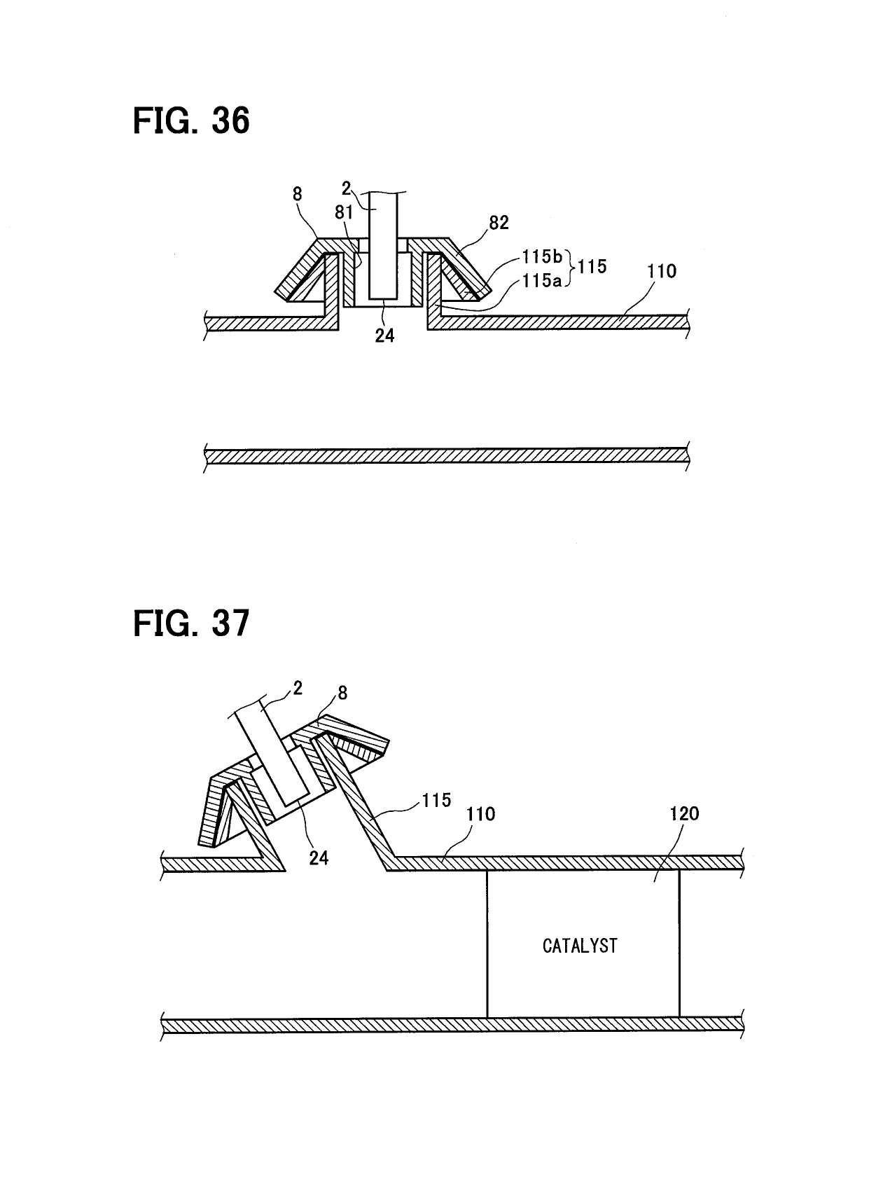

The injector 2 is fixed to the exhaust pipe 110, for example, as shown in FIG. 36. As shown in FIG. 27, in a similar manner to the above embodiments, the injector supporting unit 1 is composed of the outside housing member 3 (also referred to as an outside cover member 3), the inside housing member 4 (also referred to as an inside cover member 4), multiple partitioning walls 6, the seal member 72, the outer fixing member 8 and so on. The injector supporting unit 1 corresponds to a cooling device for the injector 2.

The cylindrical wall portion 31 of the outside cover member 3 is formed in such a shape that a diameter thereof is constant in the direction of the center axis line L1.

A wall surface of the accommodation portion 41 (that is, the inner peripheral surface of the inside cover member 4) is formed in such a way that an inner diameter is changed in a stepwise manner along the axial direction of the inside cover member 4, in a similar manner to the outer peripheral surface of the injector 2. More exactly, in the axial direction from the downstream side to the upstream side in FIG. 27, the accommodation portion 41 is composed of a first accommodation portion 411, a second accommodation portion 412 having an inner diameter larger than that of the first accommodation portion 411, and a third accommodation portion 413 having an inner diameter larger than that of the second accommodation portion 412.

The first accommodation portion 411 is formed in the cylindrical shape having the inner diameter slightly larger than an each outer diameter of the injection-hole plate 23 (forming a part of the forward end 24 of the injector 2), the nozzle body 21 and the first cylindrical portion 221. The first accommodation portion 411 accommodates the injection-hole plate 23, the nozzle body 21 and a part of the first cylindrical portion 221. In the present embodiment, a small clearance is formed between the inner peripheral surface of the first accommodation portion 411 and the injector 2.

The second accommodation portion 412 accommodates a remaining part of the first cylindrical portion 221 and the seal member 72. In other words, the second accommodation portion 412 functions as a fixing portion for the seal member 72 and the second accommodation portion 412 is formed in the cylindrical shape having the inner diameter larger than that of the first accommodation portion 411 by the thickness of the seal member 72. The outer peripheral surface of the seal member 72 of the annular shape is in contact with the inner peripheral surface of the second accommodation portion 412, while the inner peripheral surface of the seal member 72 is in contact with the outer peripheral surface of the injector 2. Accordingly, the injector 2 is indirectly in contact with the inside cover member 4 via the seal member 72. A position of the center axis line L1 of the injector 2 is defined by the second accommodation portion 412. More exactly, the center axis line L1 of the injector 2 coincides with a center axis line L2 of the second accommodation portion 412, as indicated in FIG. 27.

The third accommodation portion 413 accommodates another part of the injector 2, that is, a portion on an upstream side of the first cylindrical portion 221 and including the second cylindrical portion 222. The third accommodation portion 413 is formed in the cylindrical shape having the inner diameter larger than the outer diameter of the injector 2. The inner diameter of the third accommodation portion 413 is changed in the stepwise manner in accordance with a stepwise change of the outer diameter of the injector 2.

As shown in FIG. 28, not an entire portion of the injector 2 but a part of the injector 2 including the forward end 24 is accommodated in the accommodation portion 41. A remaining part of the injector 2 on the upstream side of the accommodation portion 41 is outwardly extending from the accommodation portion 41 in the axial-upward direction.

The first to the third accommodation portions 411 to 413 may be so formed that respective center axis lines thereof coincide with one another. Alternatively, each of the center axis lines may be displaced from the other center axis lines in the radial direction. In the embodiment shown in FIG. 27, a center axis line L3 of the first accommodation portion 411 for accommodating the forward end portion of the injector 2 (including the injection-hole plate 23 and the nozzle body 21) is eccentrically located from the center axis line L2 of the second accommodation portion 412 for defining the position of the center axis line L1 of the injector 2. When the center axis line L3 is eccentrically located from the center axis line L2, the center axis line L1 of the injector 2 is eccentrically located with respect to the center axis line L3 of the first accommodation portion 411. Then, it has an advantage that an increase of temperature at the forward end portion of the injector 2 can be more effectively suppressed, as explained below.

An outer peripheral surface 420 of the inside cover member 4 is formed in a cylindrical shape having its center axis line coinciding with the center axis line of the accommodation portion 41 or with a line parallel to the center axis line of the accommodation portion 41. An axial side of the inside cover member 4 closer to the first accommodation portion 411 is referred to as a downstream side (a lower side) of the inside cover member 4, while another axial side of the inside cover member 4 closer to the third accommodation portion 413 is referred to as an upstream side (an upper side) of the inside cover member 4. The outer peripheral surface 420 is so formed that an outer diameter thereof is decreased in a stepwise manner along the axial direction from the upstream side to the downstream side of the inside cover member 4. More exactly, the outer peripheral surface 420 has a first outer surface 421, a second outer surface 422 having an outer diameter smaller than that of the first outer surface 421, a third outer surface 423 having an outer diameter smaller than that of the second outer surface 422, a fourth outer surface 424 having an outer diameter smaller than that of the third outer surface 423, and a fifth outer surface 425 having an outer diameter smaller than that of the fourth outer surface 424. The first to the fifth outer surfaces 421 to 425 are coaxially formed with one another.

The first outer surface 421 has the outer diameter larger than an outer diameter of the outside cover member 3. The second outer surface 422 has the outer diameter equal to an inner diameter of the outside cover member 3 (that is, equal to an inner diameter of the recessed portion 33). Each of the third and the fourth outer surfaces 423 and 424 has the outer diameter smaller than the inner diameter of the outside cover member 3. The fifth outer surface 425 has the outer diameter equal to an inner diameter of the through-hole 34 formed at the bottom portion 32 of the outside cover member 3. The first to the third outer surfaces 421 to 423 form an outer peripheral surface of the third accommodation portion 413. The fourth outer surface 424 forms outer peripheral surfaces of the first and the second accommodation portions 411 and 412.

The inside cover member 4 is provided in such a manner that a lower side thereof is pointed to the bottom portion 32 of the outside cover member 3 and a part of the inside cover member 4 is inserted into the recessed portion 33 of the outside cover member 3. More exactly, a cylindrical portion 430 of the inside cover member 4, which is defined by the second to the fifth outer surfaces 422 to 425, is inserted into the recessed portion 33. The forward end projection 42, which is defined by the fifth outer surface 425, is inserted into the through-hole 34 of the outside cover member 3. The cylindrical portion, which is defined by the third outer surface 423 and the fourth outer surface 424, forms an inner wall 450 of the fluid passage for the cooling water. The inner wall 450 is located at a position opposing to a side wall surface of the recessed portion 33 (the inner peripheral surface of the outer cover member 3) in the radial direction with a gap. The cylindrical portion, which is defined by the second outer surface 422, forms a ceiling portion 460. The ceiling portion 460 is located at a position, at which the ceiling portion 460 is in contact with the inner peripheral surface of the outside cover member 3 at the open end thereof. In other words, the ceiling portion 460 closes the open end of the recessed portion 33. A cylindrical portion, which is defined by the first outer surface 421, forms a large-diameter portion 470. The large-diameter portion 470 is located at an outside of the recessed portion 33 of the outside cover member 3 in the axial direction.

The inside cover member 4 is fixed to the outside cover member 3 by the welding or the like. In a case of the welding, the inside and the outside cover members 4 and 3 are fixed to each other at such contacting portions between the outside cover member 3 and the ceiling portion 460, between the outside cover member 3 and the forward end projection 42 and so on.

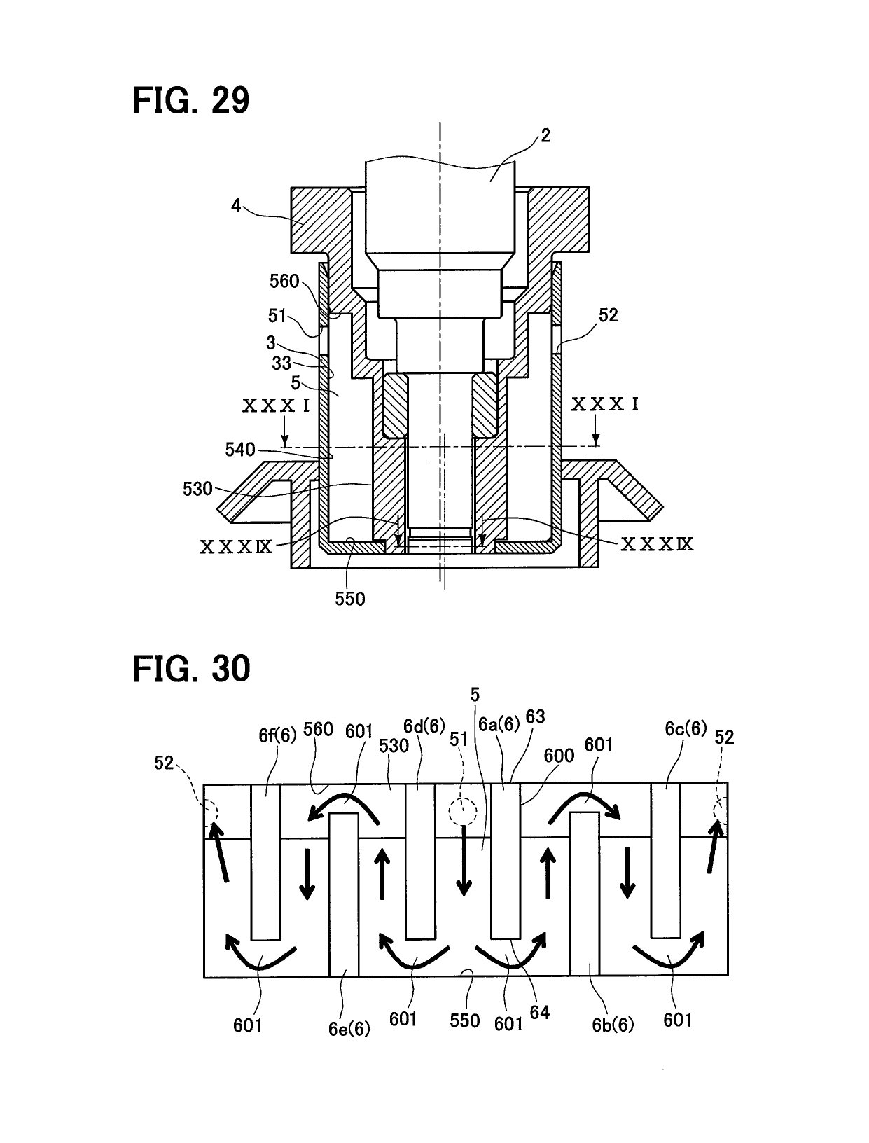

The fluid space 5 is formed in the recessed portion 33 between the outside cover member 3 and the inside cover member 4, as shown in FIGS. 28 and 29. The fluid space 5 works as the fluid passage, through which the cooling water flows for cooling down the injector 2. The cooling water for the engine is used as the cooling water for the injector 2. The fluid space 5 surrounds the whole circumference of the forward end portion of the injector 2 via the inside cover member 4. In other words, the fluid space 5 is so formed as to surround the whole circumference of the injector 2 around its center axis line L1 and to extend in the axial direction (in the direction of the center axis line L1).

More exactly, the fluid space 5 has an inside inner peripheral surface 530 and an outside inner peripheral surface 540, each of which surrounds the whole circumference of the injector 2 around its center axis line L1 and extends in the axial direction. The inside and the outside inner peripheral surfaces 530 and 540 are opposed to each other in the radial direction of the injector 2. The inside inner peripheral surface 530 (corresponding to third and the fourth outer surfaces 423 and 424 of the inside cover member 4) is pointed in a radial-outward direction of the injector 2. The outside inner peripheral surface 540 (corresponding to a part of the inner peripheral surface of the outside cover member 3) is pointed in a radial-inward direction of the injector 2.

The axial direction of the outside cover member 3, that is, the direction between the inlet side of the recessed portion 33 and the bottom portion 32 is also referred to as the depth direction. The fluid space 5 is closed at each end of the depth direction. More exactly, one end of the fluid space 5 in the depth direction (the lower-side end) is closed by the bottom portion 32 of the recessed portion 33 of the outside cover member 3. The other end of the fluid space 5 in the depth direction (the upper-side end) is closed by the ceiling portion 460 of the inside cover member 4. In the present embodiment, a wall surface of the fluid space 5 in the depth direction, which is formed at the bottom portion 32, is referred to as a lower-side surface 550. Another wall surface of the fluid space 5 in the depth direction, which is formed by the ceiling portion 460, is referred to as an upper-side surface 560.

As shown in FIG. 29, the inlet port 51 through which the cooling water enters the fluid space 5 and the outlet port 52 through which the cooling water flows out of the fluid space 5 are respectively formed for the fluid space 5. Each of the inlet port 51 and the outlet port 52 is formed at the position, at which the partitioning walls 6 are not provided in the circumferential direction of the fluid space 5 (that is, in the circumferential direction of the inside cover member 4).

Each of the inlet port 51 and the outlet port 52 is formed in the outside cover member 3 at a position neighboring to the upper-side surface 560, that is, a position closer to not the lower-side surface 550 but the upper-side surface 560, so as to pass through a wall portion of the outside cover member 3 in the radial direction thereof. In the present embodiment, the inlet port 51 and the outlet port 52 are provided at the positions separated from each other in the circumferential direction by 180 degrees (also shown in FIG. 30). It is not always necessary to provide the inlet port 51 and the outlet port 52 at the positions separated in the circumferential direction by 180 degrees.

The multiple partitioning walls 6 are provided in the fluid space 5. Each of the partitioning walls 6 extends not only in the radial direction from the inside inner peripheral surface 530 to the outside inner peripheral surface 540 but also in the axial direction (in the depth direction) of the recessed portion 33 from the upper-side surface 560 to the lower-side surface 550. Each of the partitioning walls 6 straightly extends in the depth direction in parallel to the center axis line L1 of the injector 2. Each of circumferential side surfaces 600 of the partitioning wall 6 is formed by a flat surface, as shown in FIG. 30.

As shown in FIG. 34, in the present embodiment, each of the partitioning walls 6 is arranged in such a way that the circumferential side surface 600 is parallel to the center axis line L1 of the injector 2 (the angle between the partitioning wall 6 and the center axis line L1 is 0 (zero) degree. However, as shown in FIG. 35, the partitioning wall 6 may be arranged in such a way that the circumferential side wall 600 is inclined with respect to the center axis line L1 of the injector 2 by an angle “θ6” other than 0 (zero) degree.

Each of the partitioning walls 6 is formed by a flat plate member having an almost rectangular shape, as shown in FIG. 27. The circumferential side surface 600 of the partitioning wall 6 is pointed in the circumferential direction of the inside and the outside inner peripheral surfaces 530 and 540. In the present embodiment, the plate extending direction of the partitioning wall 6 in the radial direction from the inside inner peripheral surface 530 to the outside inner peripheral surface 540 is also referred to as the first plate extending direction, while the plate extending direction of the partitioning wall 6 in the axial direction (the depth direction) from the upper-side surface 560 to the lower-side surface 550 is also referred to as the second plate extending direction.

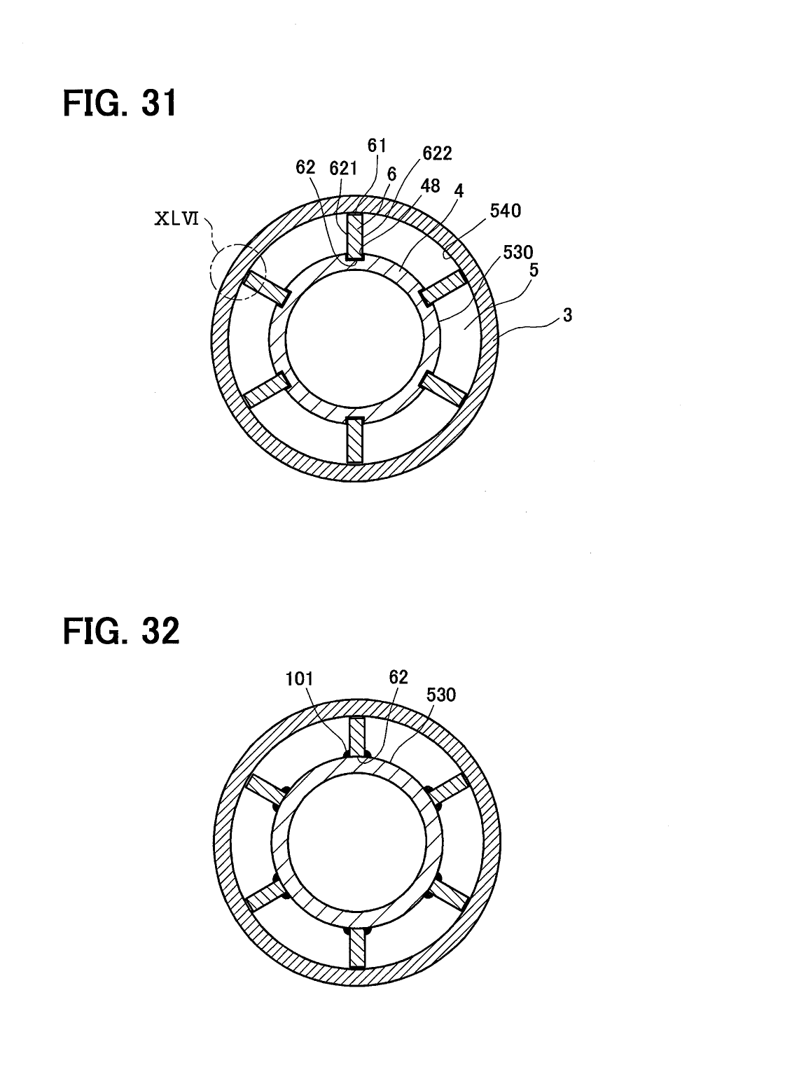

Each of the outer peripheries of the partitioning wall 6 is pointed to the corresponding wall surfaces 530 to 560 of the fluid space 5. More exactly, as shown in FIG. 31, one of the peripheral ends (the inner side end 62) of the partitioning wall 6 in the first plate extending direction is pointed to the inside inner peripheral surface 530, while the other peripheral end (the outer side end 61) is pointed to the outside inner peripheral surface 540. In addition, as shown in FIG. 30, one of the peripheral ends (the upper side end 63) of the partitioning wall 6 in the second plate extending direction is pointed to the upper-side surface 560, while the other peripheral end (the lower side end 64) is pointed to the lower-side surface 550.

In the present embodiment, the peripheral end 62 pointed to the inside peripheral surface 530 is also referred to as an inside peripheral end 62, while the peripheral end 61 pointed to the outside peripheral surface 540 is also referred to as an outside peripheral end 61. And the peripheral end 63 pointed to the upper-side surface 560 is also referred to as an upper-side peripheral end 63, while the peripheral end 64 pointed to the lower-side surface 550 is also referred to as a lower-side peripheral end 64.

The partitioning walls 6 are composed of multiple wall members 6a to 6f arranged in the fluid space 5 along the circumferential direction thereof at equal intervals. In the present embodiment, six wall members 6a to 6f are arranged in the circumferential direction at the interval of 60 degrees, as shown in FIG. 30 and/or FIG. 31.

As above, the fluid space 5 is divided by the six wall members 6a to 6f into six fluid flow areas in the circumferential direction. As shown in FIGS. 27 and 30, each of the wall members 6a to 6f forms the fluid communication portion 601, through which each fluid flow area is communicated to the neighboring fluid flow area in the circumferential direction. As shown in FIG. 30, the fluid communication portions 601 are alternately formed in the fluid space 5 at the wall members 6a to 6f on a side of the upper-side surface 560 and on a side of the lower-side surface 550 in the circumferential direction. More exactly, in each of the wall members 6a and 6d, which are respectively located at positions neighboring to the inlet port 51, an entire portion of the lower side end 64 is separated from the lower-side surface 550 in the axial direction so as to form the fluid communication portion 601 between the lower side end 64 and the lower-side surface 550. On the other hand, the upper side end 63 of each wall member 6a and 6d is in contact with (or connected to) the upper-side surface 560. In other words, no fluid communication portion is formed between the upper side end 63 and the upper-side surface 560 in the case of the wall members 6a and 6d.

In each of the wall members 6b and 6e, which are respectively located at positions neighboring to the wall members 6a and 6d, an entire portion of the upper side end 63 is separated from the upper-side surface 560 in the axial direction so as to form the fluid communication portion 601 between the upper side end 63 and the upper-side surface 560. On the other hand, the lower side end 64 of each wall member 6b and 6e is in contact with the lower-side surface 550. In other words, no fluid communication portion is formed between the lower side end 64 and the lower-side surface 550 in the case of the wall members 6b and 6e.

In addition, in each of the wall members 6c and 6f, which are respectively located at positions neighboring to the wall members 6b and 6e and to the outlet port 52, an entire portion of the lower side end 64 is separated from the lower-side surface 550 in the axial direction so as to form the fluid communication portion 601 between the lower side end 64 and the lower-side surface 550. On the other hand, the upper side end 63 of each wall member 6c and 6f is in contact with the upper-side surface 560. In other words, no fluid communication portion is formed between the upper side end 63 and the upper-side surface 560 in the case of the wall members 6c and 6f.

As a result that the fluid communication portions 601 are formed in each of the wall members 6a to 6f, the fluid communication portions 601 are alternately arranged on the side to the lower-side surface 550 and on the side to the upper-side surface 560 for the wall members 6a to 6c, which are located on a right-hand side of the inlet port 51 in FIG. 30. In a similar manner, the fluid communication portions 601 are alternately arranged on the side to the lower-side surface 550 and on the side to the upper-side surface 560 for the wall members 6d to 6f, which are located on a left-hand side of the inlet port 51 in FIG. 30.

Although a size (an opening area) of the fluid communication portion 601 is arbitrarily decided, a smaller size is preferable. When the size of the fluid communication portion 601 is made smaller, it is possible to increase flow speed of the cooling water flowing through the fluid communication portion 601, to thereby improve cooling performance of the injector 2. On the other hand, when the size of the fluid communication portion 601 becomes larger, a length of a fluid passage for the cooling water becomes correspondingly shorter.

Although the partitioning walls 6 (6a to 6f) can be fixed to any part of the injector supporting unit 1 by any suitable method, each of the wall members 6a to 6f is fixed to the inside cover member 4 in the present embodiment. For example, the partitioning walls 6 are fixed to the inside cover member 4 as shown in FIG. 31 or 32. In an example of FIG. 31, grooves 48 are formed at the outer peripheral surface of the inside cover member 4 (that is, the inside inner peripheral surface 530 of the fluid space 5). The inner side end 62 of the partitioning wall 6 is inserted into the groove 48. In an example of FIG. 32, the inner side end 62 of the partitioning wall 6 is fixed to the inside inner peripheral surface 530 by the welding at points 101. In FIGS. 31 and 32, the other portions than the outside cover member 3, the inside cover member 4 and the partitioning walls 6 are omitted.

The outer side end 61 of the partitioning wall 6 may be, or may not be, in contact with the outside cover member 3 (the outside inner peripheral surface 540 of the fluid space 5). In the example of FIG. 31, the partitioning wall 6 is not in contact with the outside cover member 3. As shown in FIG. 46, which shows an enlarged view of a portion XLVI of FIG. 31, a small gap 200 is formed between the outer side end 61 of the partitioning wall 6 and the outside inner peripheral surface 540 of the fluid space 5 (the inner peripheral surface of the outside cover member 3).

When the small gap 200 is formed between the partitioning wall 6 and the outside cover member 3, it is possible to suppress a situation that heat of the outside cover member 3 is transferred to the inside cover member 4 and the injector 2 via the partitioning walls 6. As a result, the cooling performance of the injector 2 can be increased. When the small gap 200 is formed between the partitioning wall 6 and the outside cover member 3, the small gap 200 is preferably made to be smaller to such an extent that the cooling water can hardly flow through the small gap 200. More exactly, a passage area of the small gap 200 is preferably made smaller than that of the fluid communication portion 601. According to such a structure, since a pressure loss at the small gap 200 is larger than a pressure loss at the fluid communication portion 601, the cooling water flows through not the small gap 200 but the fluid communication portion 601. In other words, it is possible to prevent leakage of the cooling water through the small gap 200.

When the partitioning walls 6 are provided so as to be in contact with the outside cover member 3, it is possible to prevent a situation that the cooling water flows in the circumferential direction through the other portions than the fluid communication portion 601. When the partitioning walls 6 are in contact with the outside cover member 3, it is preferable that a contacting surface area between them is made smaller. When the contacting surface area becomes smaller, a contacting pressure can be made larger, to thereby improve a sealing performance between each partitioning wall 6 and the outside cover member 3. In addition, when the contacting surface area is made smaller, it is possible to make smaller an amount of heat to be transmitted from the outside cover member 3 to the partitioning walls 6, to thereby improve the cooling performance of the injector 2.

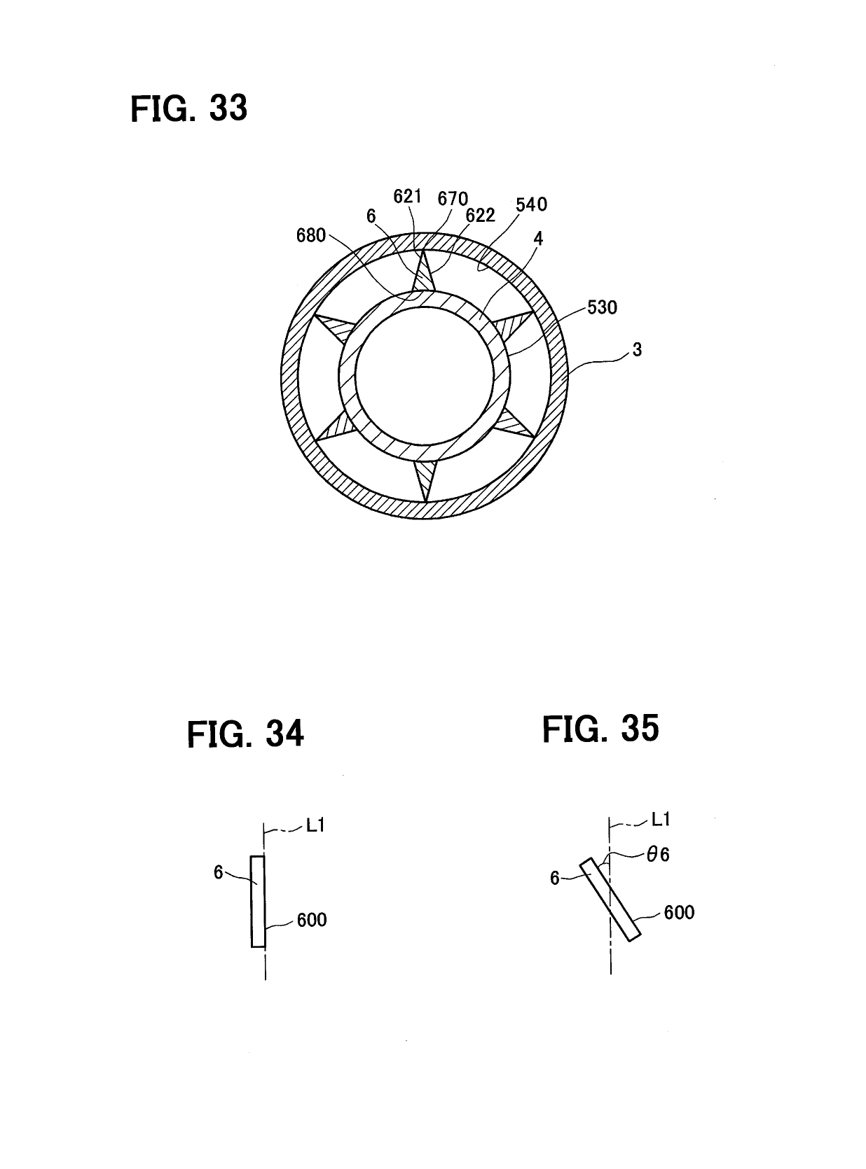

As shown in FIG. 33, a cross sectional shape of the partitioning wall 6 can be so modified as to be a triangular shape, in order that the contacting surface area between the partitioning wall 6 and the outside cover member 3 becomes smaller. The partitioning wall 6 has a first side surface 621 facing one of the fluid flow areas and a second side surface 622 facing a neighboring fluid flow area. A circumferential width between the first and the second side surfaces 621 and 622 becomes smaller in the radial direction from the inside inner peripheral surface 530 to the outside inner peripheral surface 540. The circumferential width becomes finally zero. A vertex 670 of the triangular shape is in contact with the outside inner peripheral surface 540 (the inner peripheral surface of the outside cover member 3).

According to the above structure, the partitioning wall 6 and the outside cover member 3 are in a line contact with each other, wherein the contacting portion between them extends in the axial direction. When compared with a surface contact, it is possible in the line contact not only to make larger the contacting pressure between the partitioning wall 6 and the outside cover member 3 but also to make smaller the amount of heat to be transmitted from the outside cover member 3 to the partitioning wall 6. In the example of FIG. 33, a base 680 of the triangular shape is in contact with the inside inner peripheral surface 530 (the outer peripheral surface of the inside cover member 4). In FIG. 33, the other portions than the outside cover member 3, the inside cover member 4 and the partitioning walls 6 are omitted.

As shown in FIG. 27, the seal member 72, which is formed in the annular shape, is arranged in the second accommodation portion 412 in such a manner that the inner peripheral surface of the seal member 72 is in contact with the outer peripheral surface of the injector 2 and the outer peripheral surface of the seal member 72 is in contact with the inner peripheral surface of the inside cover member 4. In other words, the injector 2 is inserted through the inside space of the seal member 72. The seal member 72 is made of the elastic material, such as rubber, or alternatively made of metal, such as copper. The seal member 72 is a part for preventing the exhaust gas from leaking out through the gap between the inside cover member 4 and the injector 2.

The outer fixing member 8 fixes the injector supporting unit 1, which is composed of the outside cover member 3, the inside cover member 4 and so on, to the exhaust pipe 110 of the engine. As shown in FIG. 27, the outer fixing member 8 has the cylindrical portion 81, a cap portion 83 and the outwardly extending portion 82. The cylindrical portion 81 has a constant inner diameter, which is larger than an outer diameter of the outside cover member 3. The cap portion 83 is formed at one of axial ends of the cylindrical portion 81 so as to close the axial end. The other axial end of the cylindrical portion 81 is formed as an open end. An opening 84 is formed in the cap portion 83. An inner diameter of the opening 84 is equal to the outer diameter of the outside cover member 3. The outwardly extending portion 82 extends from an outer periphery of the cap portion 83 in a radial-outward direction of the cylindrical portion 81 and the outwardly extending portion 82 is inclined with respect to an outer side surface of the cylindrical portion 81 in a direction to the open end of the cylindrical portion 81 (opposite to the cap portion 83). The outer fixing member 8 is also referred to as a cylindrical member 8.

The outer fixing member 8 is formed in such a way that the cap portion 83 is directed to the axial-upward direction, as shown in FIG. 27. The injector 2 and the injector supporting unit 1 are inserted into the cylindrical portion 81 through the opening 84 of the cap portion 83. The forward end portion of the injector 2 (including the forward end 24) and the part of the injector supporting unit 1 surrounding the forward end portion are accommodated in the cylindrical portion 81, while the other portions of the injector 2 and the injector supporting unit 1 are located at a position outside of the cylindrical portion 81. The outer fixing member 8 and the outside cover member 3 are fixed to each other, for example, by the welding at the opening 84.

As shown in FIG. 36, the outer fixing member 8 is attached to the exhaust pipe 110. In FIG. 36, the injector supporting unit 1 is omitted except for the outer fixing member 8. In the example of FIG. 36, the exhaust pipe 110 extends in a horizontal direction and a fixing portion 115 is formed so that it is outwardly projected from the side wall of the exhaust pipe 110 in the vertical direction. The fixing portion 115 has a cylindrical portion 115a and an outwardly extending portion 115b, wherein the cylindrical portion 115a is outwardly projected from the side wall of the exhaust pipe 110 and the outwardly extending portion 115b is extending from an open end of the cylindrical portion 115a in a direction to the side wall of the exhaust pipe 110. An inside space of the cylindrical portion 115a is communicated to the inside of the exhaust pipe 110. An inner diameter of the cylindrical portion 115a is made larger than an outer diameter of the cylindrical portion 81 of the outer fixing member 8.

The cylindrical portion 81 of the outer fixing member 8 is inserted into the cylindrical portion 115a of the fixing portion 115. The outwardly extending portion 82 of the outer fixing member 8 is brought into contact with the outwardly extending portion 115b of the fixing portion 115. Both of the outwardly extending portions 82 and 115b are fixed to each other by a fixing member (not shown).

As above, since the outer fixing member 8 is attached to the fixing portion 115 so that the inside of the outer fixing member 8 is communicated to the inside of the exhaust pipe 110, and the forward end 24 of the injector 2 is exposed to the inside of the exhaust pipe 110. Each of the inlet port 51 and the outlet port 52 is provided at a position, which is outside of the outer fixing member 8, that is, at a position outside of the exhaust pipe 110.

In the example of FIG. 36, the injector 2 is fixed to the exhaust pipe 110 so that the forward end 24 of the injector 2 is pointed in a vertical downward direction. However, the injector 2 may be fixed to the exhaust pipe 110 in a different manner, as shown in FIG. 37 or FIG. 38. In FIGS. 37 and 38, the injector supporting unit 1 is omitted except for the outer fixing member 8.

In FIG. 37, the fixing portion 115 is formed in the exhaust pipe 110 extending in the horizontal direction in such a way that its cylindrical portion 115a is outwardly projected from the outside wall of the exhaust pipe 110 and inclined with respect to the vertical direction. The injector 2 is attached to the exhaust pipe 110 by the outer fixing member 8 so that the injector 2 is inclined with respect to the vertical direction. The forward end 24 of the injector 2 is pointed in the direction to the SCR catalyst 120, which is provided in the exhaust pipe 110 at the downstream side of the injector 2.

In FIG. 38, the exhaust pipe 110 has a horizontal pipe portion 110a extending in the horizontal direction and a bent pipe portion 110b at an upstream side of the horizontal pipe portion 110a, wherein the bent pipe portion 110b is bent by an angle of 90 degrees and connected to a vertical pipe portion 110c of the exhaust pipe 110. The SCR catalyst 120 is provided in the horizontal pipe portion 110a.

The fixing portion 115 is formed at the bent pipe portion 110b in such a way that the cylindrical portion 115a is outwardly extending in the horizontal direction. As a result, the injector 2 is connected to the fixing portion 115 by the outer fixing member 8 so that the injector 2 is located in the horizontal direction and its forward end is pointed to the SCR catalyst 120.

Each of the parts and components for the injector supporting unit 1, except for the seal member 72, is made of, for example, stainless steel.

An operation and advantages of the eighth embodiment will be explained. As shown in FIG. 30, the cooling water flows into the fluid space 5 via the inlet port 51 and flows in the axial-downward direction to the lower-side surface 550 along the wall members 6a and 6d provided at both sides of the inlet port 51. A first part of the cooling water reaches the lower-side surface 550 and flows in the circumferential direction (in the right-hand direction in FIG. 30) through the fluid communication portion 601 formed at the right-hand wall member 6a. The first part of the cooling water further flows in the fluid space 5 between the neighboring wall members 6a and 6b in the axial-upward direction from the lower-side surface 550 to the upper-side surface 560 and between the neighboring wall members 6b and 6c in the axial-downward direction from the upper-side surface 560 to the lower-side surface 550. Then, the cooling water flows again in the axial-upward direction and flows out of the fluid space 5 via the outlet port 52. In a similar manner, a second part of the cooling water reaches the lower-side surface 550 and flows in the circumferential direction (in the left-hand direction in FIG. 30) through the fluid communication portion 601 formed at the left-hand wall member 6d. The second part of the cooling water further flows in the fluid space 5 between the neighboring wall members 6d and 6e in the axial-upward direction from the lower-side surface 550 to the upper-side surface 560 and between the neighboring wall members 6e and 6f in the axial-downward direction from the upper-side surface 560 to the lower-side surface 550. Then, the cooling water flows again in the axial-upward direction and flows out of the fluid space 5 via the outlet port 52. In FIG. 30, flow directions of the cooling water are indicated by arrows.

As above, the cooling water flows in the fluid space 5 alternately in the axial direction and in the circumferential direction. More exactly, the first part of the cooling water flows in the right-hand direction from the inlet port 51 alternately through the lower-side fluid communication portion 601 and through the upper-side fluid communication portion 601. In a similar manner, the remaining second part of the cooling water flows in the left-hand direction from the inlet port 51 to the outlet port 52. As above, the cooling water flows in the fluid space 5 toward the outlet port 52 in the axial direction (in the upward and in the downward direction in FIG. 30) in a meandering fashion.

According to the above structure, it is possible to elongate the fluid passage length for the cooling water. It is, thereby, possible to effectively cool down the inside cover member 4 as well as the forward end portion of the injector 2, which is located inside of the inside cover member 4.

In addition, the partitioning wall 6 is in contact with the inside cover member 4. The partitioning wall 6 is also cooled down by contact between the cooling water and the circumferential side surface 600 of the partitioning wall 6. The inside cover member 4 is further cooled down by the partitioning wall 6, which is connected to the inside cover member 4. Accordingly, the injector 2 can be further effectively cooled down.

In a case that the partitioning wall 6 is not provided, the cooling water directly flows in the fluid space 5 from the inlet port 51 to the outlet port 52 in a minimum fluid path. The cooling water in the fluid space 5 adjacent to the forward end 24 of the injector 2 stays longer in such a portion of the fluid space 5. As a result, in the above case having no partitioning wall 6, it becomes difficult to effectively cool down the forward end 24 of the injector 2.

According to the present embodiment, it becomes possible to reduce an amount of the cooling water when the cooling performance is increased. When the flow amount of the cooling water is reduced, pressure loss can be correspondingly decreased. When the pressure loss is decreased, a load of a pump for supplying the cooling water can be made smaller.

On the other hand, as already explained above, according to the structure of the above second prior art (JP 2012-137021), the cross sectional area of the circulation passage is made smaller than that of the supply passage for supplying the cooling water into the cooling-water passage. Therefore, the pressure loss of the cooling water is increased.

In addition, according to the present embodiment, the partitioning wall 6 is straightly extending in the axial direction, that is, in the direction along the center axis line L1 of the injector 2. According to the above second prior art (JP 2012-137021), the circular passage is formed so as to go around the injector in its circumferential direction. When compared the present embodiment with the case of the above second prior art, it is possible to more easily form the fluid passage for the cooling water.

In addition, in the above second prior art, the circular fluid passage is so formed as to go around almost an entire circumference of the injector. It is necessary to provide the inlet port and the outlet port at such positions, which are different from each other in the axial direction of the injector, that is, at different height positions in the axial direction. According to the present embodiment, however, it is possible to provide the inlet port 51 and the outlet port 52 at such positions, each of which has a height almost equal to each other. In other words, each of the inlet port 51 and the outlet port 52 can be formed at the position close to the upper-side surface 560. As above, it is possible to increase design flexibility for the positions of the inlet port and the outlet port.

As explained above, the center axis line L3 of the first accommodation portion 411, into which the forward end portion of the injector 2 is inserted, is eccentrically arranged with the center axis line L2 of the second accommodation portion 412 in which the seal member 72 is located. As a result, the center axis line L1 of the injector 2 is eccentric to the center axis line L3 of the first accommodation portion 411. In other words, as shown in FIG. 39, a gap “e” is non-uniformly formed in the circumferential direction between the forward end portion of the injector 2 and the inner peripheral surface of the inside cover member 4 (the wall surface of the first accommodation portion 411). When the gap “e” is non-uniformly formed, it is possible to more effectively decrease the temperature at the forward end portion of the injector 2.

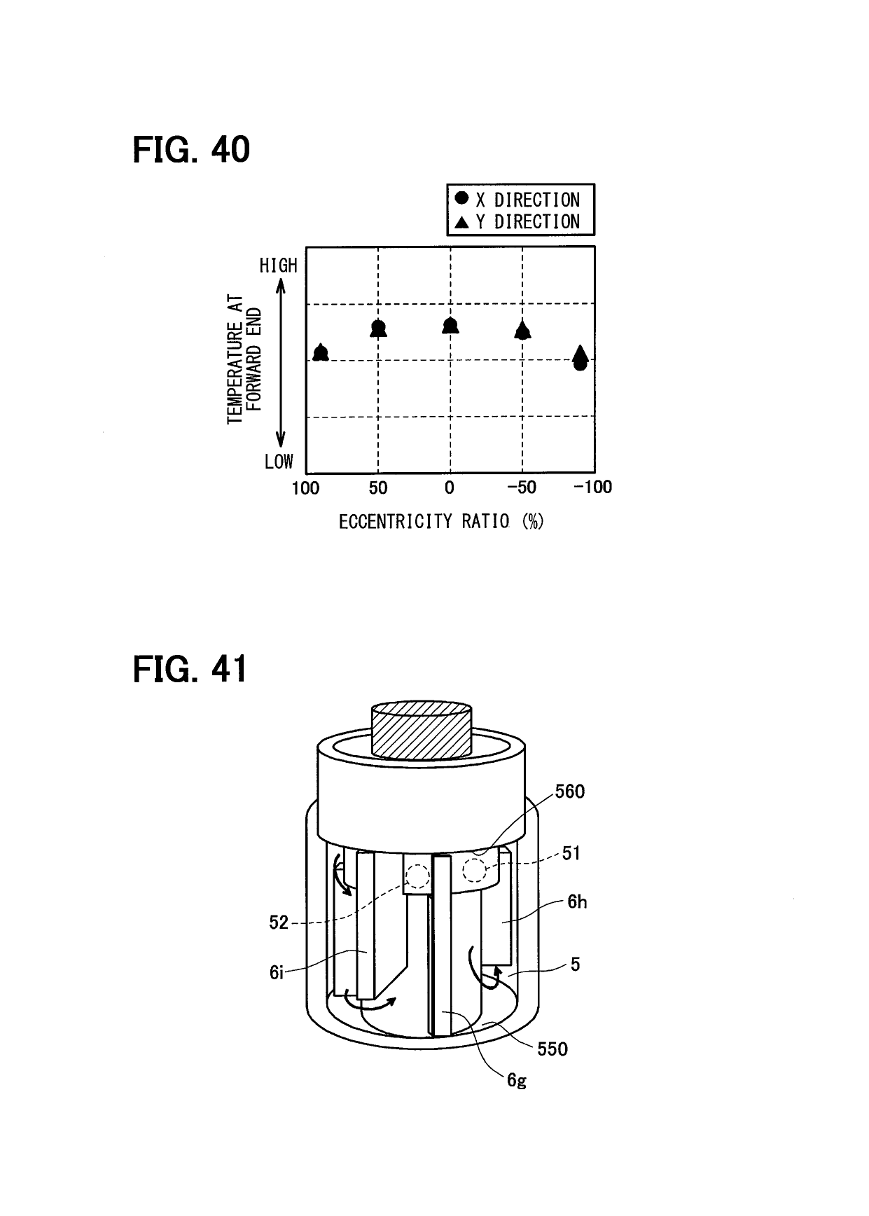

FIG. 40 is a graph showing the temperature decrease at the forward end portion of the injector 2, when the gap “e” is non-uniformly formed. More exactly, FIG. 40 shows a relationship between an eccentricity ratio and the temperature at the forward end portion of the injector 2. The eccentricity ratio in a horizontal axis of FIG. 40 indicates an eccentricity of the center axis line L1 of the injector 2 with respect to the center axis line L3 of the first accommodation portion 411 of the inside cover member 4. Namely, a gap “e0” obtained when the center axis line L1 coincides with the center axis line L3 (a reference position of the first accommodation portion 411) is set as a reference gap and a ratio of an eccentricity amount of the injector 2 with respect to the reference gap “e0” is indicated as the eccentricity ratio in FIG. 40. Therefore, when the eccentricity ratio is 0%, the eccentricity amount of the injector 2 is zero. Namely, the center axis line L1 of the injector 2 coincides with the center axis line L3 of the first accommodation portion 411. When the eccentricity ratio is 100%, the injector 2 is eccentric from the reference position of the first accommodation portion 411 by the gap “e0”. In this case, the outer peripheral surface of the injector 2 is in contact with the inner peripheral surface of the inside cover member 4 in an eccentric radial direction. On the other hand, there exists a gap of “2×e0” at an opposite side of the injector 2 in the eccentric radial direction. When the eccentricity ratio is 50%, the injector 2 is eccentric from the reference position of the first accommodation portion 411 by a gap of “e0×50%”.

In FIG. 39, a direction corresponding to a flow direction of the exhaust gas is indicated by a white arrow in an X-axis, while a direction perpendicular to the flow direction of the exhaust gas corresponds to a Y-axis. A positive direction of the X-axis (a direction to a left-hand side in FIG. 39) is opposite to the flow direction of the exhaust gas, while a negative direction of the X-axis corresponds to the flow direction of the exhaust gas. The Y-axis is perpendicular to the center axis line L1 of the injector 2 and the X-axis.

FIG. 40 shows the temperature at the forward end portion of the injector 2, when the injector 2 is eccentrically displaced in the X-axis and in the Y-axis. A positive value of the eccentricity ratio indicates that the injector 2 is eccentric in the positive direction of the X-axis or the Y-axis of FIG. 39. A negative value of the eccentricity ratio indicates that the injector 2 is eccentric in the negative direction of the X-axis or the Y-axis.

As shown in FIG. 40, the temperature at the forward end portion of the injector 2 can be decreased, when the injector 2 is eccentrically displaced from the first accommodation portion 411 in either direction of the X-axis and Y-axis and in addition when the injector 2 is eccentrically displaced in either direction of the positive direction and the negative direction of the X-axis or the Y-axis. An amount of the temperature decrease at the forward end portion of the injector 2 becomes larger as the eccentricity ratio becomes larger. Although not explained in the present disclosure, the inventors of the present disclosure have further confirmed through experiments that a heat transmission ratio from the exhaust gas to the forward end portion of the injector becomes smaller as the eccentricity ratio becomes larger.

When the injector 2 is eccentrically displaced from the first accommodation portion 411 of the inside cover member 4, a flow of the exhaust gas is changed in an area adjacent to the forward end portion of the injector 2, when compared with a case in which the injector 2 is not eccentrically displaced. More exactly, a part of a main flow of the exhaust gas flows to the area adjacent to the forward end portion of the injector 2 and thereby the temperature of the injector 2 is increased. However, it is possible to reduce an amount of the exhaust gas flowing into the area adjacent to the forward end portion when the injector 2 is eccentrically displaced from the first accommodation portion 411. It is, therefore, possible to suppress the temperature increase of the injector 2. As shown in FIG. 40, the injector 2 can be eccentrically displaced from the first accommodation portion 411 in any direction. There is no limitation for the direction of the eccentricity of the injector 2.

### Ninth Embodiment

A ninth embodiment of the present disclosure will be explained by focusing on such portions different from the eighth embodiment.

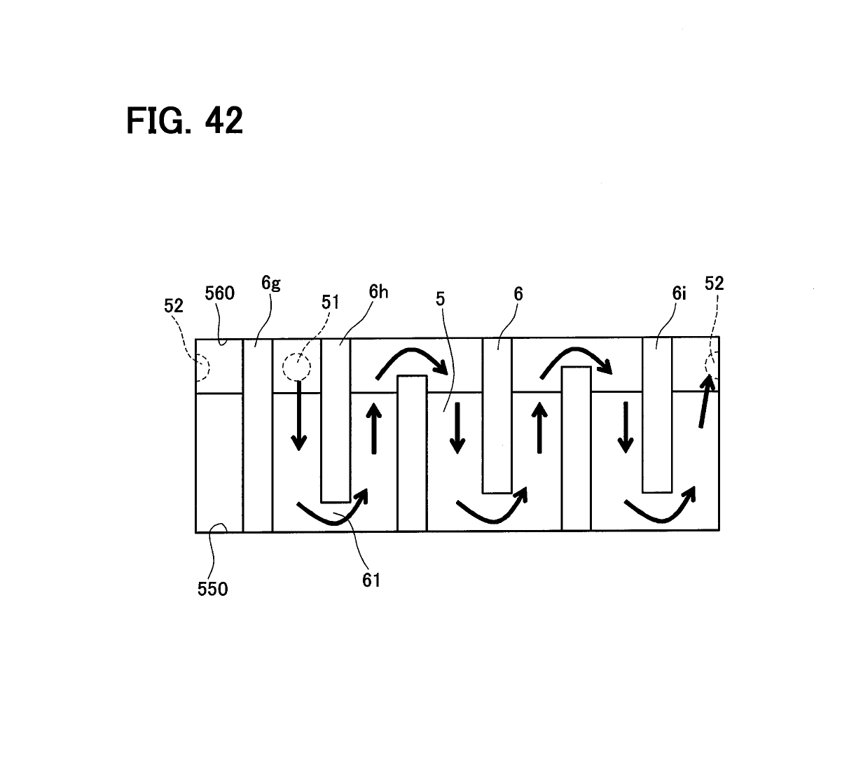

In the eighth embodiment, the cooling water flows in the fluid space in two circumferential directions (in the right-hand and in the left-hand direction in FIG. 30). However, according to the present embodiment, as shown in FIGS. 41 and 42, the cooling water flows in the fluid space in one circumferential direction.

As shown in FIGS. 41 and 42, the inlet port 51 and the outlet port 52 are located at positions, which are neighboring to each other in the circumferential direction over a wall member 6g. The wall member 6g does not have a fluid communication portion for communicating the fluid space 5 in the circumferential direction. The wall member 6g extends in the axial direction and is in contact with each of the lower-side surface 550 and the upper-side surface 560.

The wall members 6 are arranged in the circumferential direction at equal intervals in the same manner to the eighth embodiment and the fluid communication portion 601 is formed in each of the wall members 6, except for the wall member 6g, alternately on the side of the lower-side surface 550 and on the side of the upper-side surface 560. In each of the wall members 6h and 6i, each of which is respectively located at a position next to the inlet port 51 and at a position next to the outlet port 52, the fluid communication portion 601 is formed at an axial end of the respective wall member 6h, 6i on the side closer to the lower-side surface 550 (opposite to the inlet and the outlet ports 51 and 52 in the axial direction).

According to the above structure, the cooling water flows in the fluid space 5 in one circumferential direction, while the cooling water flows in the meandering fashion in the axial direction and in the circumferential direction, as indicated by arrows in FIG. 42. The same advantages to those of the eighth embodiment can be also obtained in the present embodiment. In addition, for example, in the example shown in FIG. 38, even in a case that each of the inlet port 51 and the outlet port 52 should be located at a position (or an area) 400 below the injector 2 in the vertical direction and the inlet port 51 and the outlet port 52 should be located at the positions close to each other in the circumferential direction, it is possible to circulate the cooling water in the fluid space entirely in the circumferential direction of the injector 2 when the ninth embodiment of FIGS. 41 and 42 is applied to such a case of FIG. 38.

### Further Modifications

The present disclosure is not limited to the above embodiments (including the eighth and ninth embodiments) but can be further modified in various manners without departing from the spirit of the present disclosure.

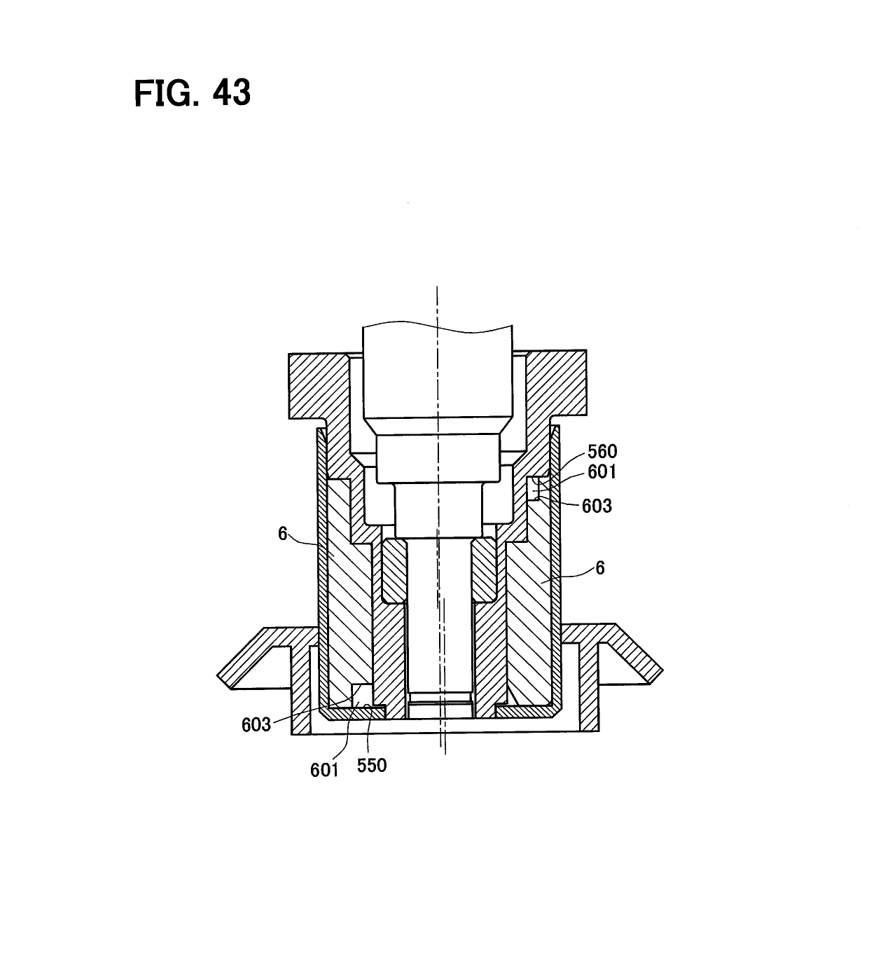

For example, in the eighth embodiment, either the lower-side axial end or the upper-side axial end of each wall member 6a to 6f is separated from the lower-side surface 550 or the upper-side surface 560 of the fluid space 5 in order to form the fluid communication portion 601 for communicating the fluid space 5 in the circumferential direction. However, according to a modification, as shown in FIG. 43, each of the lower-side axial end and the upper-side axial end of each wall member 6 is respectively in contact with the lower-side surface 550 and the upper-side surface 560. The notched portion 603 is formed either at the lower-side or the upper-side axial end of the wall member 6 to form the fluid communication portion 601, while each of the lower-side axial end and the upper-side axial end of the wall member 6 is respectively in contact with the lower-side surface 550 and the upper-side surface 560.

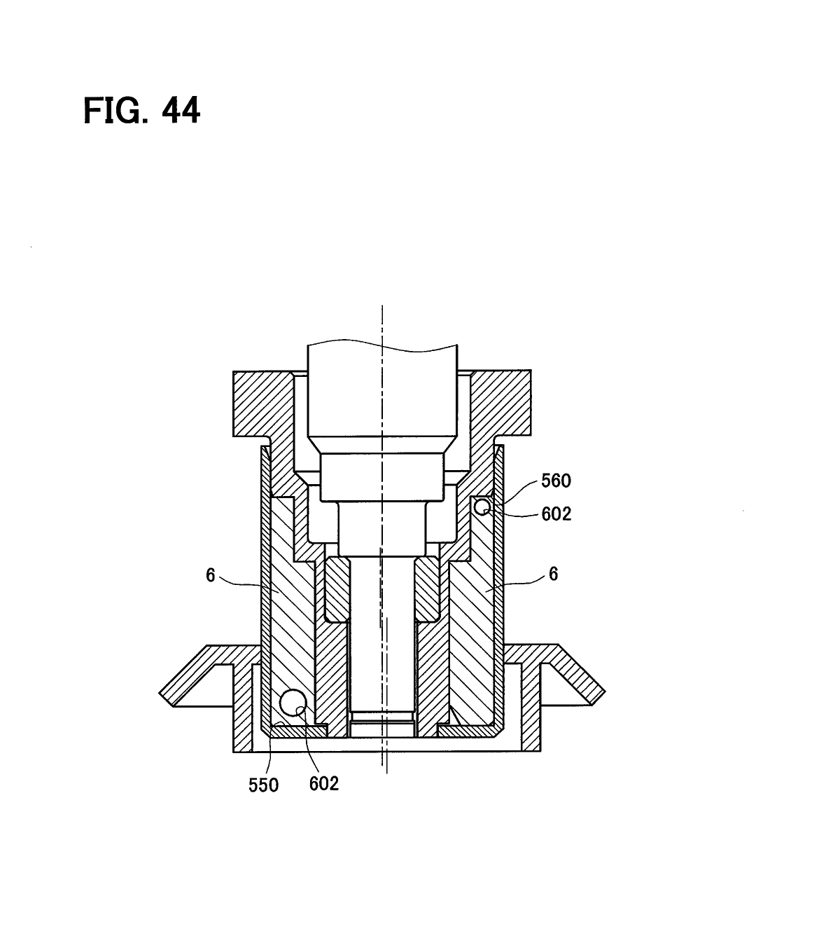

Alternatively, as shown in FIG. 44, the through-hole 602 is formed at the portion adjacent to the lower-side axial end or the upper-side axial end of each wall member 6, while each of opposite ends to the lower-side axial end and the upper-side axial end of the wall member 6 is respectively in contact with the lower-side surface 550 and the upper-side surface 560. According to such a structure, each of the through-holes 602 works as the fluid communication portion for communicating the fluid space 5 in the circumferential direction. In the present modification, a number of the through-hole 602 for each wall member 6 is not necessarily limited to one.

In the above eighth embodiment, the center axis line of the injector is eccentrically displaced from the center axis line of the first accommodation portion for accommodating the forward end portion of the injector, in order to suppress the temperature increase at the forward end portion of the injector.

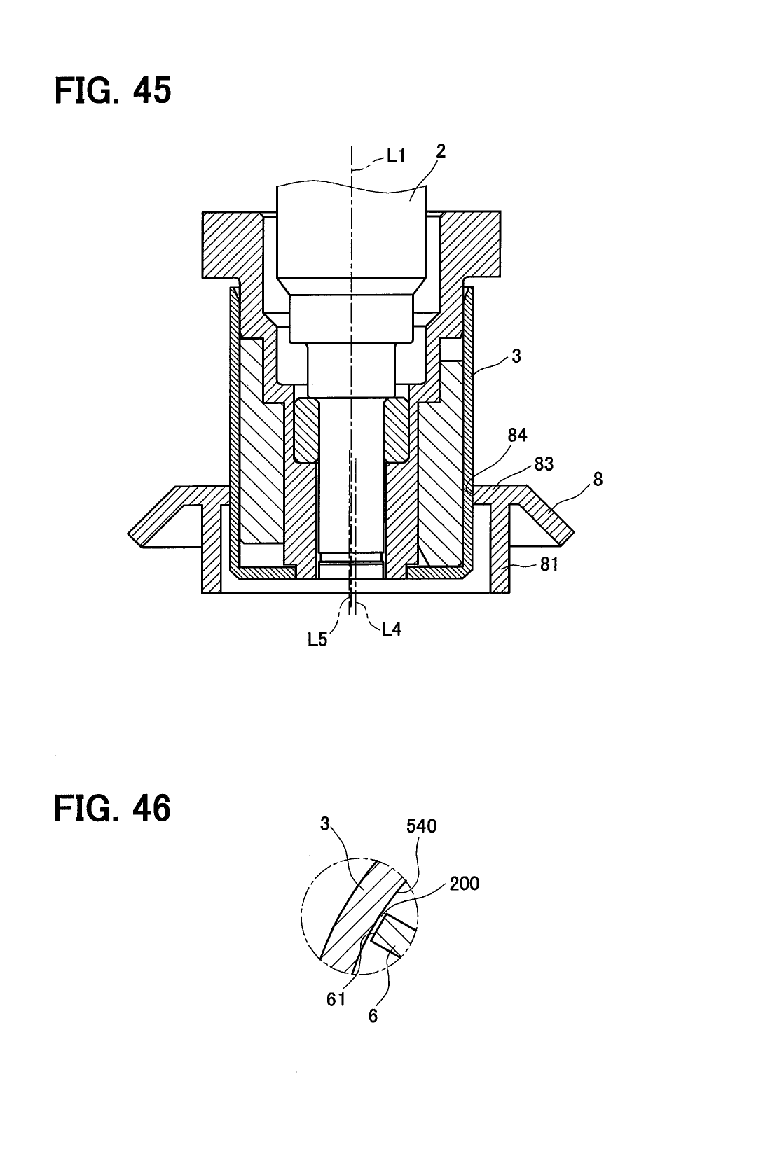

However, according to a further modification, as shown in FIG. 45, the center axis line L1 of the injector 2 can be eccentrically displaced from a center axis line L4 of the cylindrical portion 81 of the outer fixing member 8. In this case, when a center axis line L5 of the opening 84 formed in the cap portion 83 of the outer fixing member 8 is eccentrically displaced from the center axis line L4 of the cylindrical portion 81, the center axis line L1 of the injector 2 can be eccentrically displaced from the center axis line L4 of the cylindrical portion 81. Even according to the structure of FIG. 45, it is possible to change the flow of the exhaust gas in the area adjacent to the forward end portion of the injector 2, to thereby control the temperature at the forward end portion of the injector in a temperature decreasing direction.

Each of the inlet port and the outlet port may be located at any position in the axial direction. For example, each of the inlet and the outlet ports may be provided at a lower side of the fluid space. Alternatively, one of the inlet and the outlet ports is provided at an upper side of the fluid space, while the other port is provided at the lower side of the fluid space. A number of the wall members is not limited to the number in the above embodiments. Furthermore, the present disclosure can be applied to a cooling device of such an injector, which injects fluid other than the urea aqueous solution into the exhaust pipe, for example, an injector for injecting unburnt fuel into the exhaust pipe.

What is claimed is:

1. A cooling device for a fluid injection valve, which injects fluid into an exhaust pipe of an internal combustion engine comprising;
an outside housing member formed in a cylindrical shape and having a cylindrical inside space;
an inside housing member formed in a cylindrical shape and inserted into the cylindrical inside space of the outside housing member so that the outside housing member and the inside housing member are connected to each other to forma fluid space of an annular shape between the outside housing member and the inside housing member, wherein the inside housing member has a cylindrical inside space into which the fluid injection valve is inserted so that the fluid injection valve is supported by the inside housing member, wherein a forward end portion of the fluid injection valve is surrounded by the fluid space in a circumferential direction of the inside housing member, and wherein cooling water is supplied into the fluid space and flows through the fluid space in order to cool down the fluid injection valve;
an inlet port formed in the outside housing member and communicated to the fluid space so that the cooling water flows into the fluid space through the inlet port;
an outlet port formed in the outside housing member and communicated to the fluid space so that the cooling water flows out of the fluid space through the outlet port;
multiple partitioning walls provided in the fluid space at such positions which are separated from each other in the circumferential direction, each of the partitioning walls extending in an axial direction and a radial direction of the fluid space to thereby divide the fluid space into multiple fluid flow areas, wherein the fluid flow areas include a first fluid flow area and a second fluid flow area, wherein the multiple fluid flow areas are arranged in the circumferential direction of the fluid space, and wherein the inlet port is communicated to the first fluid flow area and the outlet port is communicated to the second fluid flow area; and
a fluid communication portion formed at each of the partitioning walls so as to communicate neighboring fluid flow areas to each other in the circumferential direction so that the cooling water flows from the first fluid flow area to the second fluid flow area through the fluid communication portion to thereby cool down the fuel injection valve.

2. A cooling device for a fluid injection valve provided in an exhaust pipe of an internal combustion engine and injecting fluid into the exhaust pipe comprising;
a fluid-space forming unit extending in an axial direction of the fluid injection valve to a forward end of the fluid injection valve, the fluid-space forming unit having an inner wall member and an outer wall member and surrounding the forward end of the fluid injection valve, and the fluid-space forming unit forming a fluid space between the inner wall member and the outer wall member in order that cooling water flows through the fluid space;
at least two partitioning walls provided in the fluid space at such positions which are separated from each other in a circumferential direction of the fluid injection valve, each of the partitioning walls extending in an axial direction of the fluid injection valve so as to divide the fluid space into multiple fluid flow areas arranged in the circumferential direction of the fluid injection valve;
wherein each of the partitioning walls forms a fluid communication portion in a forward-end space of the fluid space and the forward-end space surrounds the forward end of the fluid injection valve, so that the forward-end space is entirely communicated through the fluid communication portions in its circumferential direction,
wherein the multiple fluid flow areas include an inlet-side fluid space and an outlet-side fluid space, which are separated from each other in the circumferential direction by the partitioning walls,
wherein an inlet port is provided in the fluid-space forming unit at a position, which is different from a portion of the fluid space communicated to the forward-end space, so that the inlet port is communicated to the inlet-side fluid space except for the forward-end space, and
wherein an outlet port is provided in the fluid-space forming unit at a position, which is different from the portion of the fluid space communicated to the forward-end space, so that the outlet port is communicated to the outlet-side fluid space except for the forward-end space.

3. The cooling device for the fluid injection valve according to claim 2, wherein
the partitioning wall is in a line contact with an inner peripheral surface of the outer wall member.

4. The cooling device for the fluid injection valve according to claim 2, wherein
the partitioning wall is formed in such a shape that applies a spring force to the partitioning wall for pushing the outer wall member in a radial direction of the fluid injection valve.

5. The cooling device for the fluid injection valve according to claim 2, wherein
the partitioning wall has an inside plate portion and an outside plate portion in a cross section on a plane perpendicular to the axial direction of the fluid injection valve,
the inside plate portion extends along the inner wall member in the circumferential direction and is in contact with the inner wall member,
the outside plate portion is connected to one of circumferential ends of the inside plate portion and extends from the circumferential end to a forward end portion of the outside plate portion in a radial-outward direction in such a way that each point of the outside plate portion comes closer to not only another circumferential end of the inside plate portion but also the outer wall member when the point comes closer to the forward end portion, and
the partitioning wall has a spring force acting in a direction for increasing an angle formed between the inside plate portion and the outside plate portion.

6. The cooling device for the fluid injection valve according to claim 5, wherein
the outside plate portion has a bent portion at a position close to the forward end portion in the cross section on the plane perpendicular to the axial direction of the fluid injection valve,
the bent portion is in contact with the outer wall member, so that the outside plate portion is not in contact with the outer wall member except for the bent portion.

7. The cooling device for the fluid injection valve according to claim 5, wherein
an end surface of the forward end portion of the outside plate portion is inclined with respect to an inner peripheral surface of the outer wall member, so that only an edge portion of the forward end portion is in contact with the outer wall member.

8. The cooling device for the fluid injection valve according to claim 5, wherein
a radial space is formed between the inside plate portion and the outside plate portion of the partitioning wall on a side of the inlet-side fluid space.

9. The cooling device for the fluid injection valve according to claim 2, wherein
an inlet-side angle formed between a first and a second radial lines on a side of the inlet-side fluid space is smaller than 180 degrees,
wherein the inlet-side angle is an angle in the cross section on the plane perpendicular to the axial direction of the fluid injection valve,
wherein the first radial line corresponds to a line connecting one of the partitioning walls to a center position of a center axis line of the fluid injection valve, and
wherein the second radial line corresponds to another line connecting the other of the partitioning walls to the center position of the center axis line of the fluid injection valve.

10. The cooling device for the fluid injection valve according to claim 2, wherein
the partitioning wall is inclined with respect to the axial direction of the fluid injection valve, so that a cross sectional area of the inlet-side fluid space at a downstream side of the fluid space is smaller than a cross sectional area of the inlet-side fluid space at an upstream side of the fluid space,
wherein each of the cross sectional areas corresponds to an area in the cross section on the plane perpendicular to the axial direction of the fluid injection valve, and
wherein the fluid communication portions are formed at the downstream side of the fluid space.

11. The cooling device for the fluid injection valve according to claim 10, wherein
an entire portion of the partitioning wall is inclined with respect to the axial direction of the fluid injection valve.

12. The cooling device for the fluid injection valve according to claim 10, wherein
a forward end portion of the partitioning wall is inclined with respect to the axial direction,
wherein the forward end portion is a part of the partitioning wall, which is located at the downstream side of the fluid space.

13. The cooling device for the fluid injection valve according to claim 2, wherein
each of the partitioning walls extending in the axial direction of the fluid injection valve forms a first partitioning wall portion,
a second partitioning wall portion is provided in the fluid space in such a manner that the second partitioning wall portion extends in the circumferential direction of the fluid injection valve so as to separate the forward-end space from a remaining space of the fluid space, wherein the remaining space includes the inlet-side fluid space and the outlet-side fluid space,
a first opening is formed in the second partitioning wall portion so as to communicate the inlet-side fluid space of the remaining space to the forward-end space, and
a second opening is formed in the second partitioning wall portion so as to communicate the outlet-side fluid space of the remaining space to the forward-end space.

14. The cooling device for the fluid injection valve according to claim 13, wherein
the first opening and the second opening are arranged at positions, which are symmetric with respect to a center axis line of the fluid injection valve.

15. A cooling device for a fluid injection valve of an internal combustion engine comprising;
an outside housing member having a recessed portion;
an inside housing member formed in a cylindrical shape and inserted into the recessed portion in such a way that an outer peripheral surface of the inside housing member is opposed to an inner peripheral surface of the outside housing member in a radial direction of the outside housing member via a radial space, wherein the inside housing member accommodates therein the fluid injection valve so as to surround a circumference of a forward end portion of the fluid injection valve which injects fluid into an exhaust pipe of the internal combustion engine;
a fluid space of annular shape formed in the recessed portion between the outside housing member and the inside housing member, wherein cooling water is supplied into the fluid space in order to cool down the forward end portion of the fluid injection valve;
an inlet port formed in the outside housing member and communicated to the fluid space;
an outlet port formed in the outside housing member and communicated to the fluid space;
multiple partitioning walls, each of which is provided in the fluid space and extends not only in a radial direction of the fluid space from its inside peripheral surface to its outside peripheral surface but also in an axial direction of the fluid space, wherein the partitioning walls are arranged in a circumferential direction of the fluid space at intervals so that the fluid space is divided into multiple fluid flow areas neighboring to each other in the circumferential direction; and
a fluid communication portion formed in at least one of the partitioning walls for communicating neighboring fluid flow areas to each other in the circumferential direction of the fluid space, so that the cooling water flows in the fluid space in the circumferential direction from one of the fluid flow area to the neighboring fluid flow area through the fluid communication portion.

16. The cooling device for the fluid injection valve according to claim 15, wherein
each of the fluid communication portions is formed alternately, in the circumferential direction, at one of the axial ends of the partitioning wall and at the other of the axial ends of the neighboring partitioning wall.

17. The cooling device for the fluid injection valve according to claim 15, wherein
a small gap is formed between the partitioning wall and the outside inner peripheral surface of the fluid space in the radial direction.

18. The cooling device for the fluid injection valve according to claim 15, wherein
a width of the partitioning wall in the circumferential direction between one of side surfaces facing to one of the fluid flow areas and the other of the side surfaces facing to the neighboring fluid flow area becomes smaller in the radial direction from a radial inside portion to a radial outside portion, and
the partitioning wall is in contact with the outside peripheral surface of the fluid space at the radial outside portion.

19. The cooling device for the fluid injection valve according to claim 18, wherein
the partitioning wall is in a line-contact with the outside inner peripheral surface of the fluid space at the radial outside portion.

20. The cooling device for the fluid injection valve according to claim 15, wherein
a first accommodation portion is formed in the inside housing member for accommodating the forward end portion of the fluid injection valve, and
a center axis line of the first accommodation portion is eccentrically displaced from a center axis line of the fluid injection valve.

21. The cooling device for the fluid injection valve according to claim 15, further comprising;
an outer fixing member having a cylindrical portion, which is attached to the exhaust pipe so that an inside space of the cylindrical portion is communicated to the exhaust pipe,
wherein the outside housing member is inserted into the inside space of the cylindrical portion, and
wherein a center axis line of the cylindrical portion is eccentrically displaced from a center axis line of the fluid injection valve.
